(19) United States
(12) Patent Application Publication
(10) Pub. No.: US 2006/0115696 A1
(43) Pub. Date: Jun. 1, 2006

(54) Hydrogen gas humidity control apparatus, fuel cell, hydrogen gas humidity controlling method, and humidity control method for fuel cell

(76) Inventors: Chiaki Kanai, Kanagawa (JP); Eigo Kubota, Tokyo (JP)

Correspondence Address: BELL, BOYD & LLOYD, LLC, P. O. BOX 1135, CHICAGO, IL, 60690-1135, US

(21) Appl. No.: 10/537,499

(22) PCT Filed: Dec. 9, 2003
(86) PCT No.: PCT/JP03/15712

§ 371 Date: Jun. 3, 2005

(51) Int. Cl. H01M 8/04; H01M 8/10; B01F 3/02

(52) U.S. Cl. 429/22; 429/30; 236/44 R

(57) ABSTRACT

An object is to provide a hydrogen gas humidity control apparatus which removes excess moisture from the fuel gas or performs humidification or dehumidification by adjusting the moisture to keep the humidity in a fuel cell constant at an appropriate level, a fuel cell using the hydrogen gas humidity control apparatus, and a hydrogen gas humidity control method. By using a moisture carrier or proton conductor, a catalyst and voltage applying means, excess moisture in a hydrogen flow path or in hydrogen chamber is removed, or humidification or dehumidification is carried out by adjusting the moisture. A hydrogen gas humidity control apparatus and a fuel cell are comprised of a fuel-side gas diffusion chamber to which hydrogen gas is supplied, a hydrogen gas chamber to which hydrogen gas is supplied, and a proton conductor which separates the fuel-side gas diffusion chamber from the hydrogen gas chamber and allows water to pass therethrough.

### CROSS REFERENCE TO RELATED APPLICATION

The present application claims priority to Japanese Patent Document Nos. P2002-378489 filed on Dec. 26, 2002, P2002-378488 filed on Dec. 26, 2002; P2003-169275 filed on Jun. 13, 2003; and P2003-169860 filed on Jun. 13, 2003, the disclosures of which are herein incorporated by reference.

### BACKGROUND

The present invention relates to a fuel cell which continuously generates power using fuel gas containing hydrogen, and a humidity controlling apparatus for the fuel cell and a humidity controlling method for the fuel cell, which are used for control, operation, and maintenance of the fuel cell.

As a fuel cell in a related art, there has been known, for example, a fuel cell apparatus to be mounted on an electronic device, which is a power source system to be mounted on a portable electronic device, such as a laptop personal computer, and uses a small-size solid polymer fuel cell using hydrogen as a fuel and air as an oxidizer {Japanese Patent Application Publication No. Hei 9-213359 (pages 3 and 4, FIG. 19)}.

The fuel cell apparatus to be mounted on an electronic device described in the Japanese Patent Application Publication No. Hei 9-213359 is characterized in that the fuel cell apparatus is comprised of a fuel cell body which generates power using hydrogen and air, a hydrogen storage cylinder for storing hydrogen to be supplied to the fuel cell body, -means for rendering the hydrogen storage cylinder detachable, means for supplying air, a structure for recovering water formed due to the power generation, means for humidifying the hydrogen supplied to the fuel cell body, a control unit for controlling the operation of generating power, and a casing for containing them together, having an air inlet/outlet and a terminal portion electrically connected to an electronic device. According to the fuel cell apparatus, because the fuel cell apparatus can be detachably mounted on a portable electronic device, it is possible to provide a new power source system, so that not only can the fuel cell apparatus continue operating for a longer time than the battery cell in the related art, but also the fuel cell apparatus can be repeatedly used by a supply of the fuel.

In addition, as a fuel cell in a related art, there is one which is described in, for example, Japanese Patent Application Publication No. 2002-100384 (pages 5 to 7, FIG. 1). In the Japanese Patent Application Publication No. 2002-100384, there is a description concerning a fuel cell and a water vapor-permeable membrane preferably used in the fuel cell.

The fuel cell described in Japanese Patent Application Publication No. 2002-100384 is comprised of a battery section for advancing a battery reaction, and a humidifier section for humidifying raw material gas supplied to the battery section; wherein the battery section has a battery cell including a solid polymer electrolyte membrane and electrodes disposed respectively on the both sides of the solid polymer electrolyte membrane, and the humidifier section is comprised of a raw material gas flow path through which raw material gas is introduced, a discharged gas flow path through which gas discharged from the battery section introduced, and a water vapor-permeable membrane which separates the flow paths; wherein water vapor contained in the discharged gas is allowed to pass through the water vapor-permeable membrane and to the raw material gas flow path from the discharged gas flow path, and the water vapor is brought into contact with the raw material gas inside the raw material gas flow path so as to humidify the raw material gas. The fuel cell is characterized in that the water vapor-permeable membrane is comprised of a substance obtained by cross-linking, using a cross-linking agent, a water-soluble polymer having 70% by weight or more of a repeating unit having a carboxyl group in the form of a metal salt as a functional group.

Further, as a fuel cell in a related art, there is one which is described in Japanese Patent Application Publication No. 2002-117878 (pages 4 and 5, FIG. 1). In the Japanese Patent Application Publication No. 2002-117878, there is a description concerning a fuel cell and a water vapor-permeable membrane preferably used for humidifying raw material gas supplied to the fuel cell.

The fuel cell described in the Japanese Patent Application Publication No. 2002-117878 is comprised of a battery section for advancing a battery reaction, and a humidifier section for humidifying raw material gas supplied to the battery portion; wherein the battery section has a battery cell including a solid polymer electrolyte membrane and electrodes disposed respectively on the both sides of the solid polymer electrolyte membrane, and the humidifier section is comprised of a raw material gas flow path through which raw material gas is introduced, a discharged gas flow path through which gas discharged from the battery section introduced, and a water vapor-permeable membrane which separates the flow paths; wherein water vapor contained in the discharged gas is allowed to pass through the water vapor-permeable membrane to the raw material gas flow path from the discharged gas flow path, and the water vapor is brought into contact with the raw material gas inside the raw material gas flow path so as to humidify the raw material gas. The fuel cell is characterized in that the water vapor-permeable membrane is comprised of a moisture permeable resin layer which is formed on the surface of a polymer resin porous film and comprised of a cured perfluorosulfonic acid ion-exchange resin.

The present applicant has developed a fuel cell having, for example, the structure shown in FIG. 24. The fuel cell shown in FIG. 24 is an apparatus which generates power by supplying fuel gas to a power-generating portion, and is comprised of four power-generating cells 1, 2, 3, and 4. The four power-generating cells 1 to 4 are configured to be connected in series to a supplying path of hydrogen as a fuel. The four power-generating cells 1 to 4 have the same structure, and the structure is described taking the fourth power-generating cell 4 as an example.

The power-generating cell 4 is comprised of a proton conductor membrane electrode assembly 5 having catalysts carried on the top and bottom surfaces thereof, an oxidizer electrode-side separator 6 disposed on one side of the proton conductor membrane electrode assembly 5, and a fuel electrode-side separator 7 disposed on another side of the proton conductor membrane electrode assembly 5. Electrodes 8, 9 are sandwiched between the proton conductor membrane electrode assembly 5 and the separators 6, 7, respectively, which are tied to be integrated together, thereby constituting the power-generating cell 4. An oxidizer inlet 6a for introducing an oxidizer, such as oxygen or air is provided to the oxidizer electrode-side separator 6. A plurality of flow paths or fuel chambers through which hydrogen as a fuel flows are formed in the fuel electrode-side separator 7 has formed therein.

The fuel cell having the above-mentioned structure generates power, for example, as follows. Hydrogen gas as a fuel is supplied to the fuel electrode-side separator 7, and air as an oxidizer is supplied to the oxidizer electrode-side separator 6. When the hydrogen gas (H2) as a fuel is supplied, hydrogen (H2) contacts with the catalyst on the proton conductor membrane electrode assembly 5 and electrons (e−) are freed, whereby protons (H+)(H2→2H++2e−) are generated. The protons (H+) move through the polymer electrolyte membrane toward the opposite side. On the opposite side, oxygen contained in the supplied air reacts with the protons (H+) and the returned electrons (e−) due to the catalyst, thereby forming water (O2+4H++4e−→2H2O).

Due to this chemical reaction, water is successively formed at the oxidizer electrode-side separator 6 side of the proton conductor membrane electrode assembly 5. When the water covers the catalyst or a gas diffusion layer on the proton conductor membrane electrode assembly 5, a satisfactory amount of oxygen required for generating power cannot enter due to a coated layer of water or high partial pressure of water vapor. Therefore, the power generation which continues by keeping supplying hydrogen and oxygen cannot proceed, it is necessary to remove the formed water to the outside.

On the other hand, in a solid polymer electrolyte fuel cell (PEFC), the proton conductor in a proton conducting membrane is water (hereinafter, referred to as “carrier water”), and hence protons do not move in a dry state such that there is no carrier water. Therefore, the proton conducting membrane is required to appropriately control in moisture content. Further, the proton conducting membrane in the PEFC back-diffuses the moisture formed on the cathode side toward the anode side, and however moisture content of the anode side becomes excess depending on the conditions, and therefore, like the cathode side, controlling the moisture content of the anode side is important.

In FIG. 24, reference numerals 10a, 10b, 10c, 10d, and 10e individually indicate flow rates of hydrogen supplied from the first power-generating cell 1 and discharged from the fourth power-generating cell 4. Reference numeral 10a indicates a flow rate of the supplied hydrogen which is 100%, and reference numeral 10b indicates a hydrogen flow rate obtained by subtracting the hydrogen amount consumed at the first power-generating cell 1. Further, reference numeral 10c indicates a hydrogen flow rate obtained by subtracting the hydrogen amount consumed at the second power-generating cell 2, and reference numeral 10d indicates a hydrogen flow rate obtained by subtracting the hydrogen amount consumed at the third power-generating cell 3. Reference numeral 10e indicates a hydrogen flow rate obtained by subtracting the hydrogen amount consumed at the fourth power-generating cell 4, and, if necessary, the remaining hydrogen is discharged from the fourth power-generating cell 4 to the atmosphere. Reference numeral 11 indicates a stop valve for the hydrogen flow path provided at the fourth power-generating cell 4.

However, in the above-mentioned Japanese Patent Application Publication No. Hei 9-213359, it is described such that the apparatus has water holding means for recovering and holding water formed in the fuel cell body. The water holding means is in a sheet form and provided on the bottom of the battery apparatus casing so that the sheet is in close contact with the fuel cell body on the side at which water is formed, and the sheet extends to be in contact with the lower surface of the hydrogen storage cylinder. It is described that, to the material for the water holding means, it can be applied a variety of highly water-absorbing polymers used in sanitary supplies, such as disposable diaper and sanitary goods, and agricultural and horticultural tools, such as a soil water holder.

For the reason that the water holding means has extremely high water-absorption properties, there are problems not only in that the humidity of the water holding means itself is likely to increase to nearly 100%, causing a state of excess moisture, but also in that the humidity control is not easy.

In addition, in the fuel cell shown in FIG. 24, the fuel gas is frequently excessively humidified under the operation conditions at around room temperature, or the humidity frequently becomes high due to the back-diffusion of moisture. Therefore, when it is presumed that hydrogen (fuel) is supplied to the power-generating cells 1 to 4 at the dead end, the partial pressure characteristics of hydrogen and water or water vapor have a tendency indicated by reference numeral 12 shown in FIG. 24.

The partial pressure characteristics 12 of hydrogen and water and the like are represented on the assumption that, in the fuel gas in the four power-generating cells 1 to 4, the partial pressure of hydrogen at the upstream end is 100% and the partial pressure of water and water vapor at the most downstream end is 100%. Specifically, the hydrogen flow rate on the side of the first power-generating cell 1 to which the fuel gas is supplied (upstream end) is 100%, and the hydrogen flow rate is gradually reduced with this hydrogen flow and the hydrogen flow rate on the side of the fourth power-generating cell 4 from which the fuel gas is discharged (downstream end) is 0% (conversely, the partial pressure of water or water vapor is 100%).

As a result, the partial pressure of water and the like in the fuel flow path on the downstream side is increased and a state lacking in hydrogen is caused. Then, the hydrogen flow rate eventually becomes 0%, and no hydrogen is supplied to the catalyst or the gas diffusion layer due to the moisture condensation or poor diffusion of water vapor, so that protons cannot be in contact with oxygen, thus making it impossible to generate power. On the other hand, the fuel flow path on the upstream side has no water or water vapor and hence lacks carrier water required for moving protons, whereby there arises a case where power is not preferably generated.

In view of the above problems accompanying the technique in the related art, the present invention has been made, and a task is to provide a hydrogen gas humidity control apparatus, which humidifies or dehumidifies fuel gas by adjusting the moisture content of the fuel gas or removing excess moisture from the fuel gas, making it possible to keep the humidity in a fuel cell constant at an appropriate level, a fuel cell using the hydrogen gas humidity control apparatus, a hydrogen gas humidity control method, and a humidity control method for a fuel cell.

### SUMMARY OF THE INVENTION

The present invention relates to a fuel cell which continuously generates power using fuel gas containing hydrogen, and a humidity controlling apparatus for the fuel cell and a humidity controlling method for the fuel cell, which are used for control, operation, and maintenance of the fuel cell.

The hydrogen gas humidity control apparatus according to an embodiment of the present application includes a first hydrogen flow path or hydrogen chamber to which at least hydrogen gas is supplied; a second hydrogen flow path or hydrogen chamber to which at least hydrogen gas is supplied; and a moisture carrier for separating the first hydrogen flow path or hydrogen chamber from the second hydrogen flow path or hydrogen chamber and for allowing water and/or water vapor to pass therethrough.

The hydrogen gas humidity control apparatus according to an embodiment of the present application includes hydrogen gas generated by fuel reforming.

The hydrogen gas humidity control apparatus according to an embodiment of the present application includes a first hydrogen flow path or hydrogen chamber to which at least hydrogen gas is supplied; a second hydrogen flow path or hydrogen chamber to which at least hydrogen gas is supplied; and a proton conductor for separating the first hydrogen flow path or hydrogen chamber from the second hydrogen flow path or hydrogen chamber.

The hydrogen gas humidity control apparatus according to an embodiment of the present application wherein the proton conductor has a catalyst disposed on at least one surface of the proton conductor selected from the surface facing the first hydrogen flow path or hydrogen chamber and the surface facing the second hydrogen flow path or hydrogen chamber.

The hydrogen gas humidity control apparatus according to an embodiment of the present application wherein a first voltage application electrode is provided to the first hydrogen flow path or hydrogen chamber; a second voltage application electrode is provided to the second hydrogen flow path or hydrogen chamber; and the proton conductor is sandwiched between the first voltage application electrode and the second voltage application electrode.

The hydrogen gas humidity control apparatus according to an embodiment of the present application wherein a voltage is applied to a portion between the first voltage application electrode and the second voltage application electrode.

The hydrogen gas humidity control apparatus according to an embodiment of the present application wherein the catalyst contains platinum.

The hydrogen gas humidity control apparatus according to an embodiment of the present application wherein the hydrogen gas is hydrogen gas generated by fuel reforming.

The fuel cell according to an embodiment of the present application includes at least one or two or more power-generating cell having a fuel electrode-side separator to which a fuel is supplied, an oxidizer electrode-side separator to which an oxidizer is supplied, and a proton conductor membrane electrode assembly sandwiched between the fuel electrode-side separator and the oxidizer electrode-side separator; and at least one or two or more hydrogen gas humidity control apparatus, which is incorporated to a hydrogen flow path and/or hydrogen chamber to which the fuel is supplied; wherein the hydrogen gas humidity control apparatus having a first substrate, a second substrate, and a moisture carrier sandwiched between the first substrate and the second substrate; wherein mixed gas of hydrogen and water and/or water vapor is in contact with the first substrate and at least hydrogen is in contact with the second substrate.

The fuel cell according to an embodiment of the present application includes at least one or two or more power-generating cell having a fuel electrode-side separator to which a fuel is supplied, an oxidizer electrode-side separator to which an oxidizer is supplied, and a proton conductor membrane electrode assembly sandwiched between the fuel electrode-side separator and the oxidizer electrode-side separator; and one or two or more hydrogen gas humidity control apparatus, which is incorporated to a hydrogen flow path and/or hydrogen chamber to which the fuel is supplied; wherein the hydrogen gas humidity control apparatus having a first electrode, a second electrode, and a proton conductor sandwiched between the first electrode and the second electrode; wherein mixed gas of hydrogen and water and/or water vapor is in contact with the first electrode and at least hydrogen is in contact with the second electrode.

The humidity control method of hydrogen gas according to an embodiment of the present application includes holding a proton conductor by sandwiching between a first electrode and a second electrode, and applying a voltage to a portion between the first electrode and the second electrode; wherein moisture is carried between hydrogen in contact with the first electrode and hydrogen in contact with the second electrode.

By virtue of having the above structure, in the hydrogen gas humidity control apparatus according to an embodiment of the present application, the first hydrogen flow path or hydrogen chamber and the second hydrogen flow path or hydrogen chamber are separated by the moisture carrier, and therefore, when the contents of water and/or water vapor in the two hydrogen flow paths or hydrogen chambers are different, the water and/or water vapor moves through the moisture carrier in the direction from the higher content to the lower content. Thus, the humidity of hydrogen can be controlled so that the contents of water and/or water vapor in the two hydrogen flow paths or hydrogen chambers are the same.

In the hydrogen gas humidity control apparatus according to an embodiment of the present application, the hydrogen gas is hydrogen gas generated by fuel reforming, and hydrogen generated by steam reforming or the like contains much moisture, and hence there can be obtained an advantageous effect such that a lack of moisture is easily avoided.

In the hydrogen gas humidity control apparatus according to an embodiment of the present application, the first hydrogen flow path or hydrogen chamber and the second hydrogen flow path or hydrogen chamber are separated by the proton conductor, and therefore, when the contents of water and/or water vapor in the two hydrogen flow paths or hydrogen chambers are different, the water and/or water vapor moves through the proton conductor in the direction from the higher content to the lower content or from the lower content to the higher content. Even when the contents are the same, the water and/or water vapor moves through the proton conductor from one side to another. Thus, the humidity of hydrogen can be controlled so that the contents of water and/or water vapor in the two hydrogen flow paths or hydrogen chambers are the same or arbitrarily selected.

In the hydrogen gas humidity control apparatus according to an embodiment of the present application, a catalyst is disposed on at least one surface of the proton conductor selected from the surface facing the first hydrogen flow path or hydrogen chamber and the surface facing the second hydrogen flow path or hydrogen chamber, and therefore the catalyst can divide hydrogen into protons or convert protons to hydrogen.

In the hydrogen gas humidity control apparatus according to an embodiment of the present application, a first voltage application electrode is provided to the first hydrogen flow path or hydrogen chamber, a second voltage application electrode is provided to the second hydrogen flow path or hydrogen chamber, and the proton conductor is sandwiched between the electrodes, and hence they can constitute a proton pump to control the humidity of hydrogen gas. Therefore, the apparatus can be used as a humidifier or dehumidifier for keeping optimal the humidity of hydrogen in the hydrogen flow path or hydrogen chamber, a humidity sensor, a vacuum regulator, a pressurizing compressor, a flow controller, or the like.

In the hydrogen gas humidity control apparatus according to an embodiment of the present application, by applying a voltage to a portion between the first voltage application electrode and the second voltage application electrode, protons can be moved through the proton conductor in the direction from the higher voltage to the lower voltage.

In the hydrogen gas humidity control apparatus according to an embodiment of the present application, by using platinum as the catalyst, hydrogen can be efficiently divided into protons, or protons can be efficiently converted to hydrogen.

In the hydrogen gas humidity control apparatus according to an embodiment of the present application, the hydrogen gas is hydrogen gas generated by fuel reforming, and hydrogen generated by steam reforming or the like contains much moisture, and hence there can be obtained an advantageous effect such that a lack of moisture is easily avoided.

In the fuel cell according to an embodiment of the present application, which includes: one or two or more power-generating cell having a fuel electrode-side separator, an oxidizer electrode-side separator, and a proton conductor membrane electrode assembly, and a hydrogen gas humidity control apparatus; wherein a moisture carrier is sandwiched between a first substrate and a second substrate in the hydrogen gas humidity control apparatus, and mixed gas of hydrogen and water and/or water vapor is in contact with the first substrate and at least hydrogen is in contact with the second substrate. Therefore, when the humidity of hydrogen in the hydrogen flow path or hydrogen chamber through which the fuel is supplied is high, the hydrogen is dehumidified by permitting excess water and/or water vapor to pass through the moisture carrier toward the side of lower humidity, or, when the humidity of hydrogen in the hydrogen flow path or hydrogen chamber is low, the hydrogen is humidified by introducing water and/or water vapor from the side of higher humidity through the moisture carrier, thus making it possible to keep efficiently generating power.

In the fuel cell according to an embodiment of the present application, which includes: one or two or more power-generating cell having a fuel electrode-side separator, an oxidizer electrode-side separator, and a proton conductor membrane electrode assembly, and a hydrogen gas humidity control apparatus; wherein a proton conductor is sandwiched between a first electrode and a second electrode in the hydrogen gas humidity control apparatus, and mixed gas of hydrogen and water and/or water vapor is in contact with the first electrode and at least hydrogen is in contact with the second electrode. Therefore, by applying a voltage to a portion between the electrodes, water and/or water vapor can be moved in the direction from the higher voltage to the lower voltage, and, by controlling the direction of the voltage application, the humidity of hydrogen in the two hydrogen flow paths or hydrogen chambers is adjusted, thus making it possible to keep efficiently generating power.

In the humidity control method of hydrogen gas according to an embodiment of the present application, by holding the proton conductor by sandwiching between a first electrode and a second electrode and applying a voltage to a portion between the first electrode and the second electrode, moisture is carried between the hydrogen which is supplied to the fuel electrode in a fuel cell and in contact with the first electrode, and the hydrogen which has a humidity different from that of the hydrogen in contact with the first electrode and is in contact with the second electrode, and therefore water and/or water vapor can be moved in the direction from the higher voltage to the lower voltage, and, by controlling the direction of the voltage application, the humidity of hydrogen in the two hydrogen flow paths or hydrogen chambers is adjusted, thus making it possible to keep efficiently generating power in the fuel cell.

Further, for solving the above problems, the fuel cell of the present application is characterized by including: a power-generating cell having an electrolyte sandwiched between a fuel electrode and an oxygen electrode, an oxygen electrode-side separator having formed therein an oxygen flow path through which oxygen is supplied to the oxygen electrode, a fuel electrode-side separator having formed therein a fuel flow path through which fuel gas is supplied to the fuel electrode, and a moisture carrier disposed to be in contact with the fuel gas and in contact with discharged gas having a humidity different from that of the fuel gas to move moisture between the fuel gas and the discharged gas.

By virtue of the moisture carrier which is in contact with the fuel gas and the discharged gas to move moisture between the fuel gas and the discharged gas, when the fuel gas has a humidity higher than that of the discharged gas, moisture moves in the direction from the fuel gas to the discharged gas, and, when the fuel gas has a humidity lower than that of the discharged gas, moisture moves in the direction from the discharged gas to the fuel gas. Therefore, even when moisture formed due to the power generation in the fuel cell causes the humidity to be unsuitable for power generation of the power-generating cell, the movement of moisture between the discharged gas and the fuel gas is repeated, thus making it possible to keep the humidity in the fuel cell constant at an appropriate level.

The fuel cell may have a discharge flow path through which discharged gas flows, and the discharged gas containing oxygen may be supplied to the oxygen electrode side of the fuel cell. When the fuel cell has the discharge flow path through which the discharged gas flows, air from the outside of the fuel cell is supplied as the discharged gas to the discharge flow path to effectively put the discharged gas into contact with the moisture carrier, thus making it easy to keep the humidity in the fuel cell constant at an appropriate level. When the discharged gas containing oxygen is supplied to the oxygen electrode side of the fuel cell, the fuel cell can generate power using the discharged gas, thus enabling power generation effectively utilizing the discharged gas.

When the moisture carrier contains a perfluorosulfonic acid polymer, the moisture carrier can surely and easily carry moisture.

Further, for solving the above problems, the fuel gas humidity control method of the present application is characterized in that a moisture carrier is disposed to be in contact with fuel gas supplied to the fuel electrode side of a fuel cell, and discharged gas having a humidity different from that of the fuel gas and the fuel gas are separated by the moisture carrier to move moisture between the fuel gas and the discharged gas using the moisture carrier.

Additional features and advantages of the present invention are described in, and will be apparent from, the following Detailed Description and the figures.

### BRIEF DESCRIPTION OF THE FIGURES

FIG. 1 is an explanatory view showing a schematic structure of a fuel cell using a hydrogen gas humidity control apparatus in a first embodiment of the present invention.

FIG. 2 is an explanatory view showing a schematic structure of a power-generating cell in an assembled state of the fuel cell using the hydrogen gas humidity control apparatus in the first embodiment of the present invention.

FIG. 3 is an explanatory view showing another example of a piping construction in the power-generating cell in the fuel cell using the hydrogen gas humidity control apparatus in the first Embodiment of the present invention.

FIG. 4 is an explanatory view showing a schematic structure of a fuel cell using a hydrogen gas humidity control apparatus in a second embodiment of the present invention.

FIG. 5 is an explanatory view showing a schematic structure of a fuel cell using a hydrogen gas humidity control apparatus in a third embodiment of the present invention.

FIG. 6 is an explanatory view for explaining a principle of a fuel cell using a hydrogen gas humidity control apparatus in a fourth embodiment of the present invention.

FIG. 7 is an explanatory view for explaining a principle of a fuel cell using a hydrogen gas humidity control apparatus of the present invention.

FIG. 8 is an explanatory view showing a detailed structure of a modified example of the embodiment shown in FIG. 7.

FIG. 9 is an explanatory view for explaining a principle of a fuel cell using a hydrogen gas humidity control apparatus in a fifth embodiment of the present invention.

FIG. 10A is an explanatory view showing a schematic structure of a power-generating cell in the first embodiment, which shows a power-generating cell for a fuel cell using a hydrogen gas humidity control apparatus of the present invention.

FIG. 10B is an explanatory view showing a schematic structure of a power-generating cell in a second embodiment, which shows a power-generating cell for a fuel cell using a hydrogen gas humidity control apparatus of the present invention.

FIG. 11A is an explanatory view showing a schematic structure of a power-generating cell in a third embodiment, which shows a power-generating cell for a fuel cell using a hydrogen gas humidity control apparatus of the present invention.

FIG. 11B is an explanatory view showing a schematic structure of a power-generating cell in a fourth embodiment, which shows a power-generating cell for a fuel cell using a hydrogen gas humidity control apparatus of the present invention.

FIG. 12 is an explanatory view showing a schematic structure of a power-generating cell in a fifth embodiment for a fuel cell using a hydrogen gas humidity control apparatus of the present invention.

FIG. 13A is an explanatory view showing a schematic structure of a power-generating cell in a sixth embodiment, which shows a power-generating cell for a fuel cell using a hydrogen gas humidity control apparatus of the present invention.

FIG. 13B is an explanatory view showing a schematic structure of a power-generating cell in a seventh embodiment, which shows a power-generating cell for a fuel cell using a hydrogen gas humidity control apparatus of the present invention.

FIG. 14A is an explanatory view showing a schematic structure of a power-generating cell in a eighth embodiment, which shows a power-generating cell for a fuel cell using a hydrogen gas humidity control apparatus of the present invention.

FIG. 14B is an explanatory view showing a schematic structure of a power-generating cell in a ninth embodiment, which shows a power-generating cell for a fuel cell using a hydrogen gas humidity control apparatus of the present invention.

FIG. 15A is an explanatory view showing a schematic structure of a power-generating cell in a 10th embodiment, which shows a power-generating cell for a fuel cell using a hydrogen gas humidity control apparatus of the present invention.

FIG. 15B is an explanatory view showing a schematic structure of a power-generating cell in a 11th embodiment, which shows a power-generating cell for a fuel cell using a hydrogen gas humidity control apparatus of the present invention.

FIG. 16A is an explanatory view showing a schematic structure of a power-generating cell in a 12th embodiment, which shows a power-generating cell for a fuel cell using a hydrogen gas humidity control apparatus of the present invention.

FIG. 16B is an explanatory view showing a schematic structure of a power-generating cell in a 13th embodiment, which shows a power-generating cell for a fuel cell using a hydrogen gas humidity control apparatus of the present invention.

FIG. 17A is a graph showing a relationship between hydrogen humidity and a hydrogen flow path in a fuel cell using a hydrogen gas humidity control apparatus in an embodiment of the present invention.

FIG. 17B is a graph showing a relationship between hydrogen humidity and a hydrogen flow path in a fuel cell using a hydrogen gas humidity control apparatus in an embodiment of the present invention.

FIG. 18 is an explanatory view for explaining a principle of a fuel cell using a humidity control method in an embodiment of the present invention.

FIG. 19 is an explanatory view showing a schematic structure of a fuel cell using a humidity control method in an embodiment of the present invention.

FIG. 20 is an explanatory view showing a modified example of the fuel cell using the humidity control method in an embodiment of the present invention shown in FIG. 19.

FIG. 21 is a graph showing output characteristics of a relationship between a voltage and a time of a fuel cell using a humidity control method in an embodiment of the present invention.

FIG. 22 is a graph showing output characteristics of a relationship between a voltage and an internal resistance of a fuel cell using a humidity control method in an embodiment of the present invention.

FIG. 23 is a graph showing output characteristics of a relationship between a voltage and an electric current of a fuel cell using the humidity control method in an embodiment of the present invention.

FIG. 24 is an explanatory view showing a schematic structure of a fuel cell in a related art.

### DETAILED DESCRIPTION

The present invention relates to a fuel cell which continuously generates power using fuel gas containing hydrogen, and a humidity controlling apparatus for the fuel cell and a humidity controlling method for the fuel cell, which are used for control, operation, and maintenance of the fuel cell.

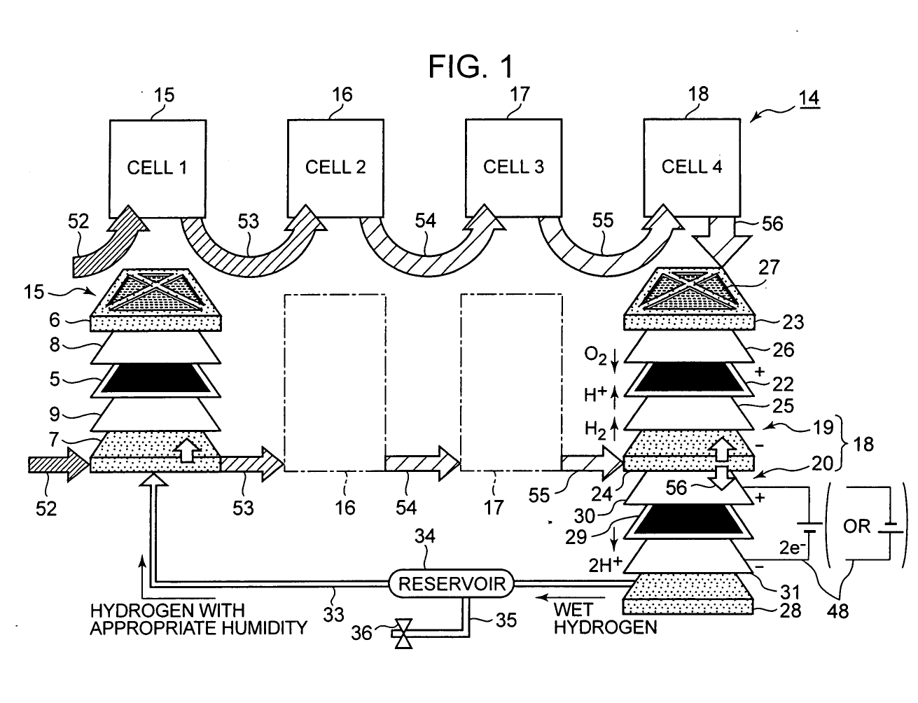

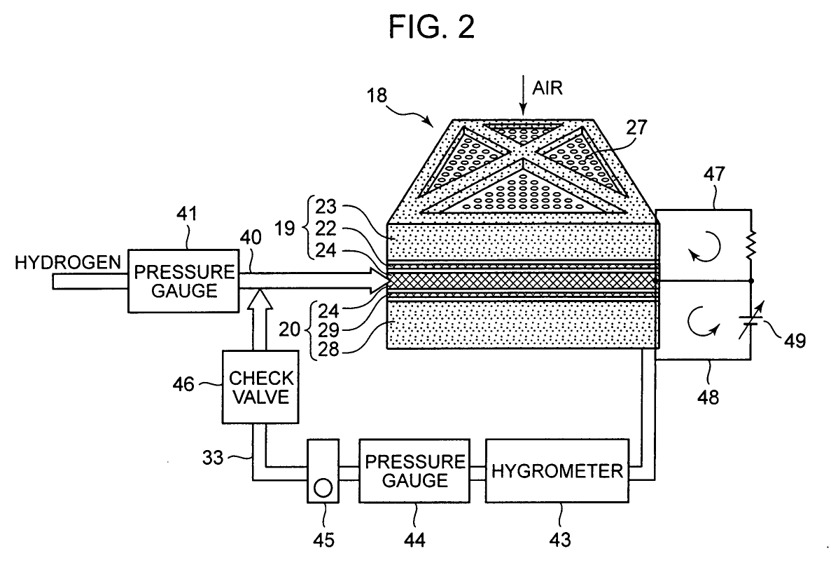

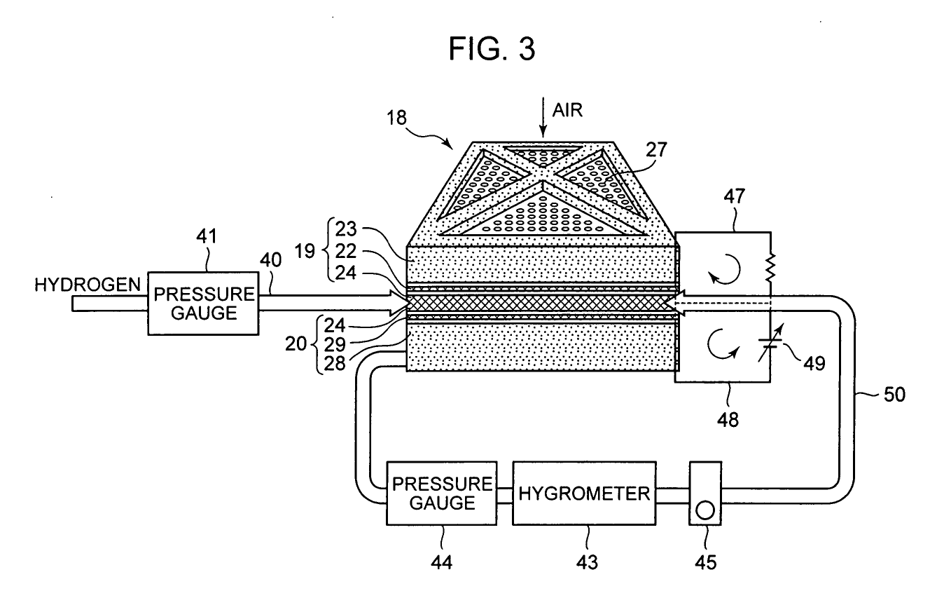

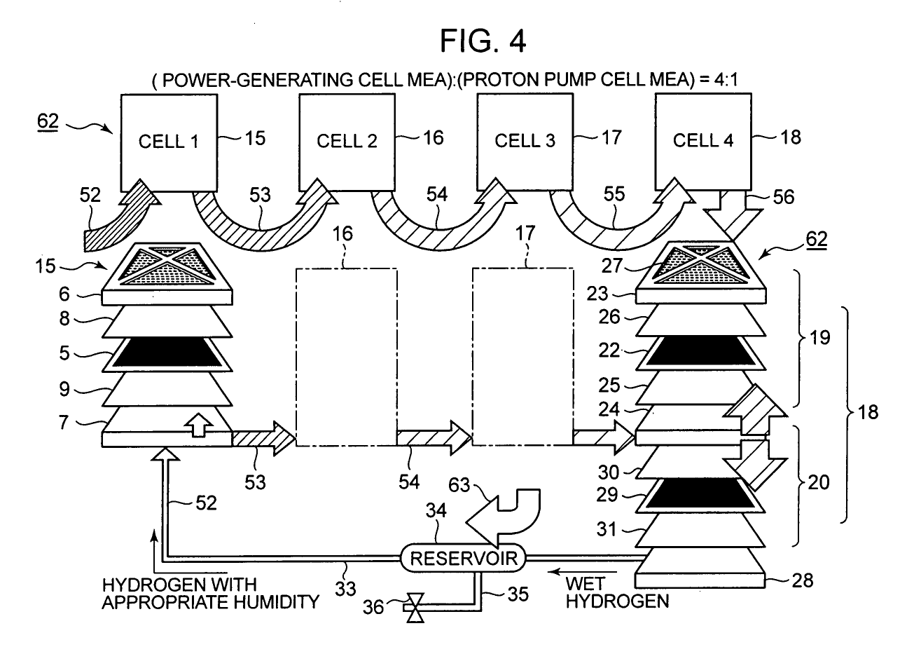

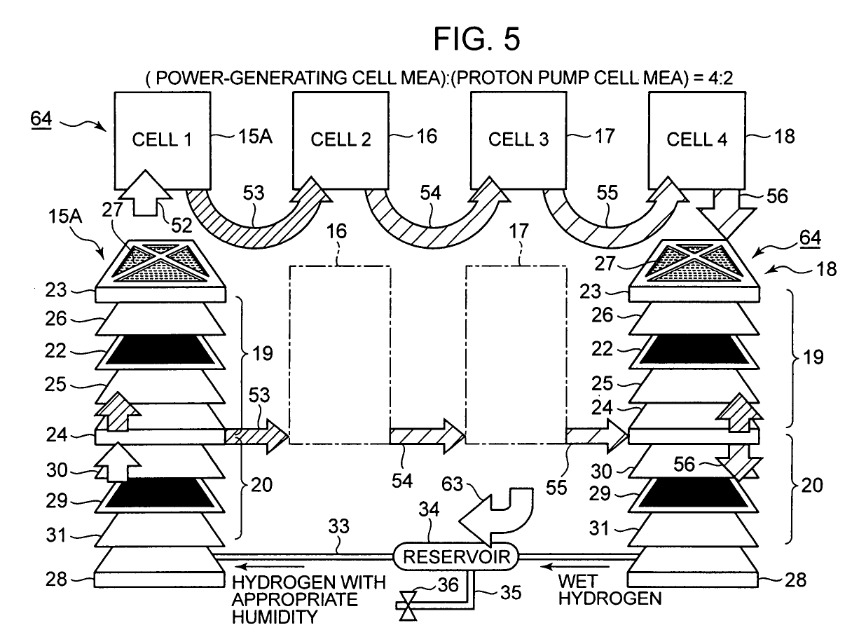

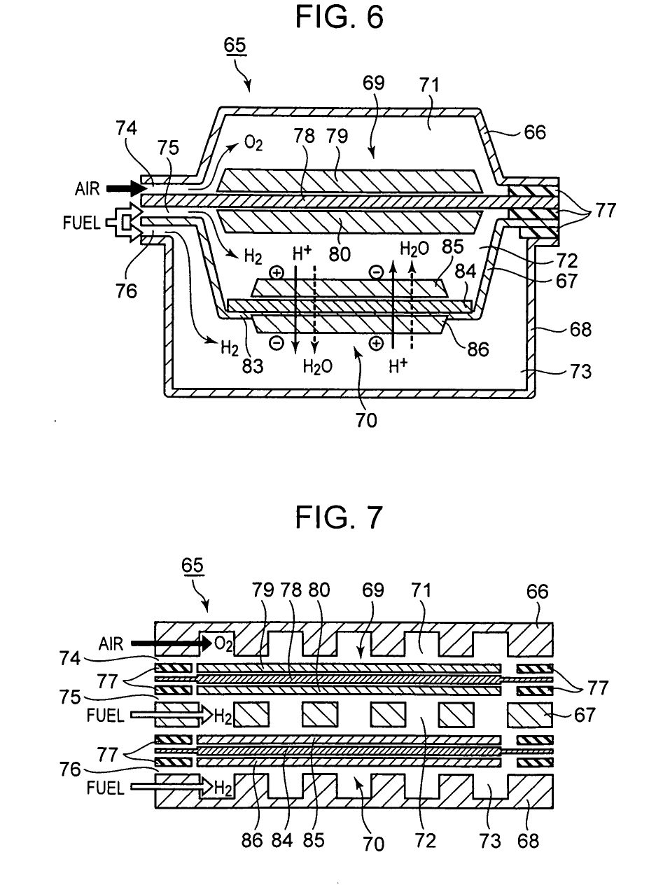

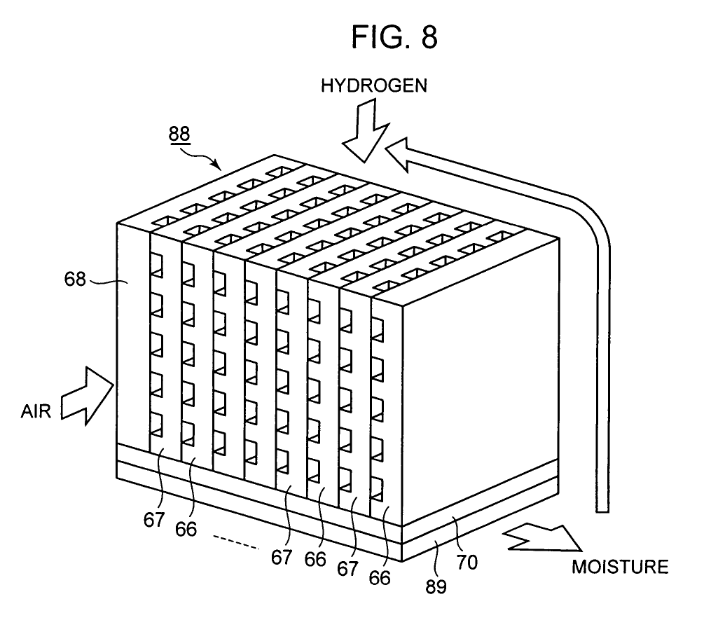

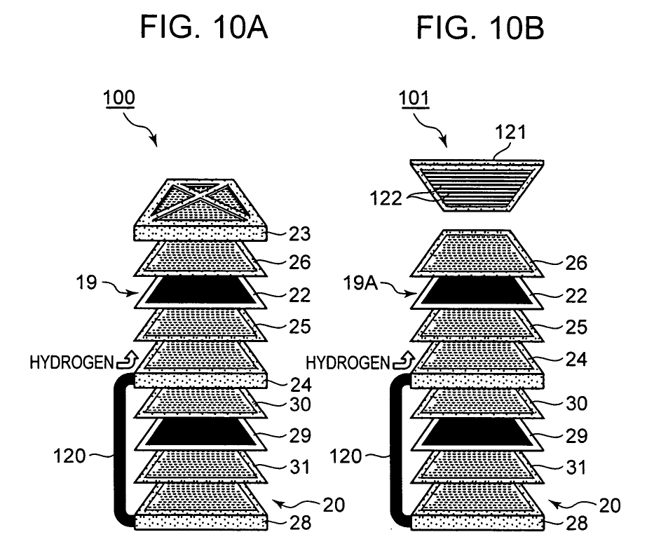

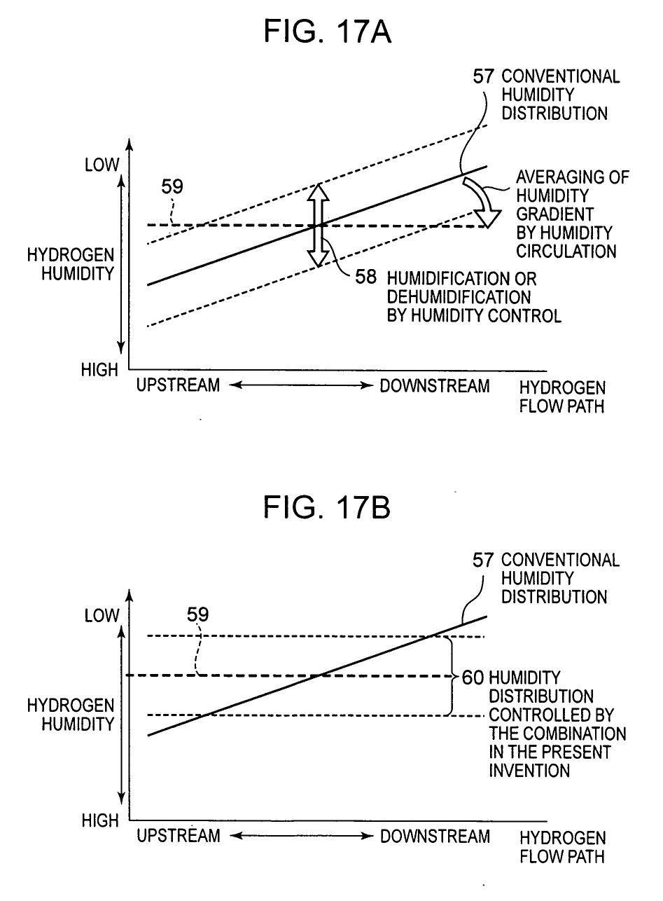

Hereinbelow, the embodiments of the present invention will be described with reference to the accompanying drawings. FIGS. 1 to 23 show the embodiments of the present invention. Specifically, FIG. 1 is an explanatory view showing a schematic structure of a fuel cell in a first embodiment of the present invention, FIG. 2 is an explanatory view showing a schematic structure of the power-generating cell in an assembled state in the first embodiment, FIG. 3 is an explanatory view showing another example of the piping construction of the power-generating cell in the first embodiment, FIG. 4 is an explanatory view showing a schematic structure of a fuel cell in a second embodiment of the present invention, FIG. 5 is an explanatory view showing a schematic structure of a fuel cell in a third embodiment of the present invention, FIG. 6 is a view for explaining a principle of a fuel cell of the present invention, FIG. 7 is an explanatory view showing an example of a detailed structure of FIG. 6, FIG. 8 is an explanatory view showing another example of a detailed structure of FIG. 7, FIGS. 10A and 10B, FIGS. 11A and 11B, FIG. 12, FIGS. 13A and 13B, FIGS. 14A and 14B, FIGS. 15A and 15B, and FIGS. 16A and 16B are explanatory views for respectively explaining a relationship between a power-generating cell and a proton pump, and FIGS. 17A and 17B are graphs for explaining a relationship between a hydrogen humidity and a hydrogen flow path.

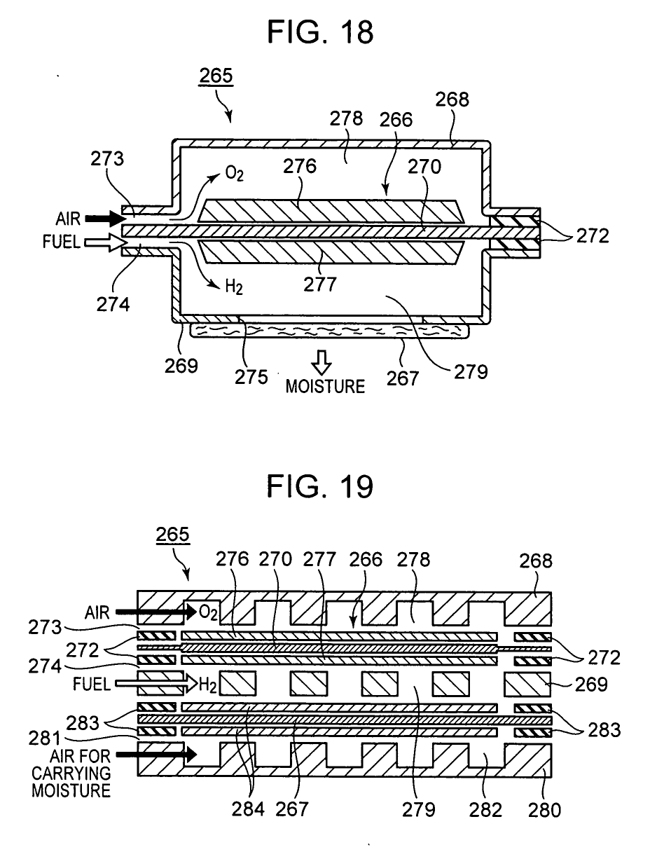

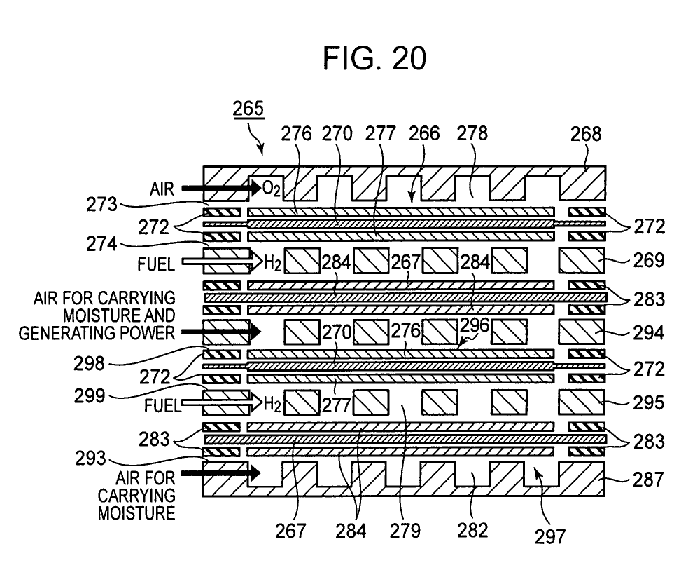

FIG. 18 is a view for explaining a principle of a fuel cell using a humidity control method of the present invention, FIG. 19 is an explanatory view showing a schematic structure of a fuel cell using a humidity control method of the present invention, and FIG. 20 is an explanatory view showing a modified example of FIG. 19.

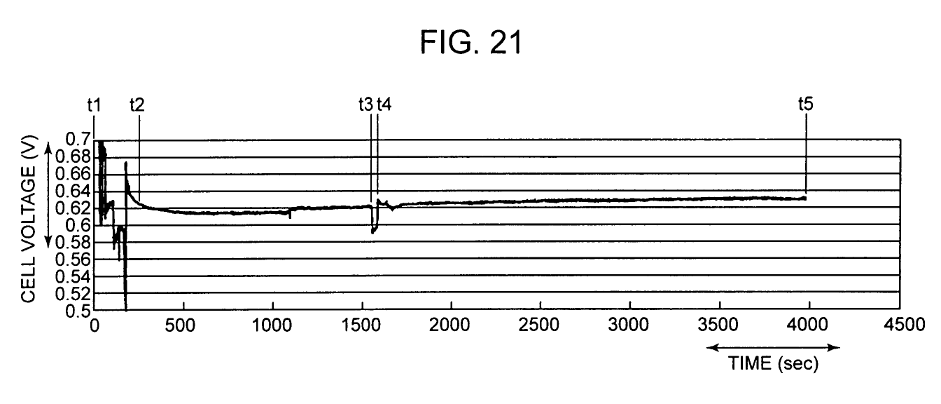

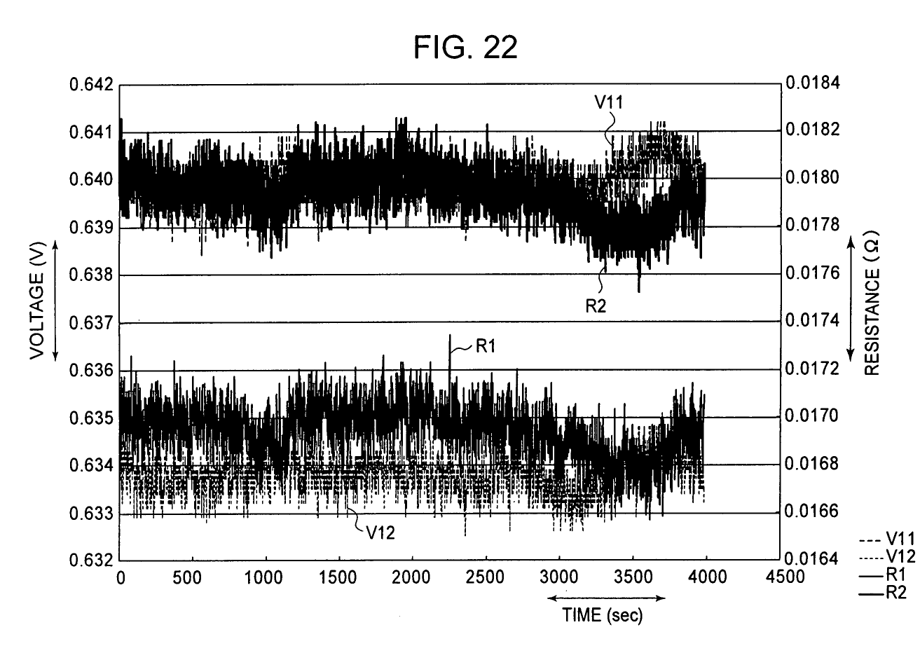

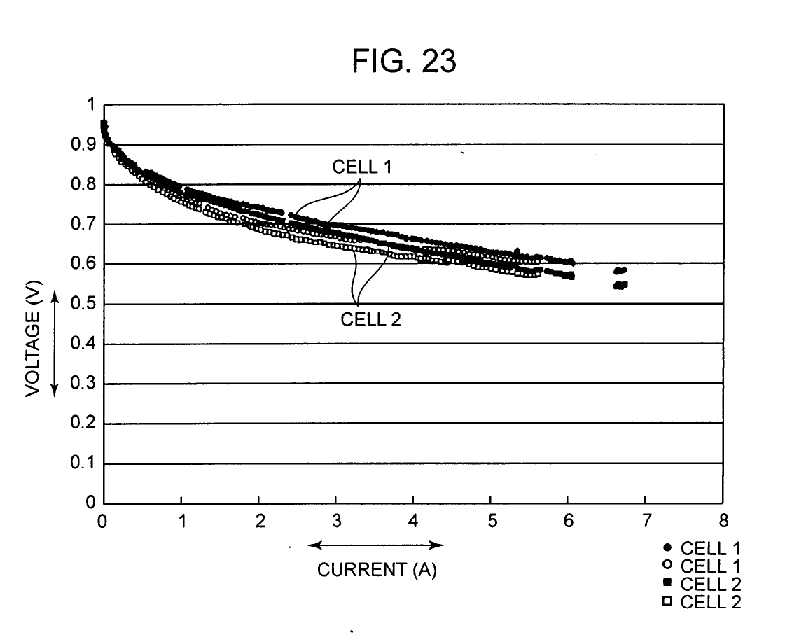

FIG. 21 is a graph showing output characteristics of a fuel cell of the present invention, representing a relationship between a cell voltage (V) and a time (sec), FIG. 22 is a graph showing a relationship between a cell voltage (V), a time (sec), and a resistance (Ω) similar to FIG. 21, and FIG. 23 is a graph showing a relationship between a cell voltage (V) and a time (sec) similar to FIG. 21.

The fuel cell of the present invention decomposes hydrogen (H2) into protons (2H+) and electrons (2e−) at the anode (positive electrode), and takes the generated electrons out in the form of power. In this instance, at the cathode (negative electrode), oxygen (O2) combines with protons, which have moved through an electrolyte membrane, and electrons, which have traveled through an external circuit, to form water as a by-product.

For making protons move through the proton conductor used in the fuel cell, water is needed, and therefore the by-produced water is diffused in the proton conductor and positively utilized for improving the proton conductivity. On the other hand, if the by-produced water is excessively generated in the proton conductor, it inhibits oxygen from moving, thus inhibiting the fuel cell from generating power. In addition, the by-produced water diffused into the hydrogen (anode) side through the proton conductor may inhibit hydrogen from moving. Therefore, for allowing the fuel cell to continue stably generating power, it is essential to keep the moisture content of the proton conductor constant in a predetermined range.

Further, the hydrogen gas humidity control apparatus controls the humidity of fuel gas (particularly hydrogen) used in a fuel cell, and uses a proton pump for moving protons with moisture. The proton pump is used for moving hydrogen via protons as well as hydrogen or moisture, and the objects which the proton pump moves are hydrogen and moisture. The amount of the hydrogen and moisture which move through the proton pump can be controlled by, for example, changing the voltage or electric current applied to a portion between the electrodes formed respectively on the both surfaces of the proton conductor membrane electrode assembly.

As shown in FIG. 1, a proton pump shown as an hydrogen gas humidity control apparatus in a first embodiment of the present invention is assembled and integrated with a fourth power-generating cell 18 positioned on the most downstream side in four power-generating cells 15, 16, 17, and 18 connected with each hydrogen flow path in series.

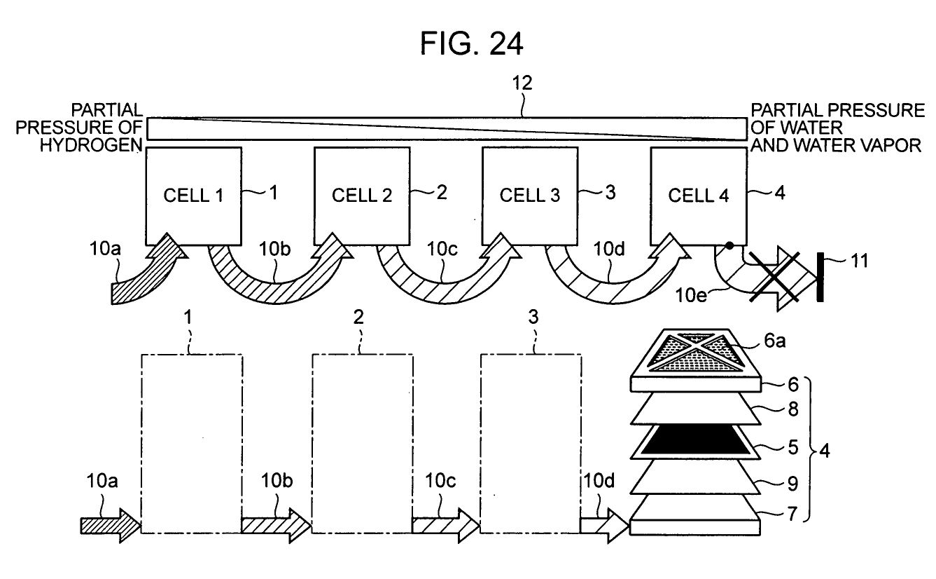

Of these, the three power-generating cells, i.e., a first power-generating cell 15, a second power-generating cell 16, and a third power-generating cell 17 individually have a structure similar to that of the power-generating cell 4 shown in FIG. 24 as an example of a related art cell. Specifically, each of the first to third power-generating cells 15 to 17 a proton conductor membrane electrode assembly 5 having catalysts carried on the top and bottom surfaces thereof, an oxidizer electrode-side separator 6 disposed on one side of the proton conductor membrane electrode assembly 5, a fuel electrode-side separator 7 disposed on another side of the proton conductor membrane electrode assembly 5, and electrodes 8, 9 sandwiched between the proton conductor membrane electrode assembly 5 and the separators 6, 7, respectively.

On the other hand, the fourth power-generating cell 18 has a power-generating section 19 having a structure similar to that of the power-generating cell 4 shown in FIG. 24, but, in addition to the power-generating section 19, a proton conductor 20, which is a hydrogen gas humidity control apparatus, is incorporated into the side of a fuel electrode separator 24. The power-generating section 19 is integrated with the proton conductor 20 to constitute the fourth power-generating cell 18. The four power-generating cells 15 to 18 including the fourth power-generating cell 18 are connected with each hydrogen flow path through which hydrogen is supplied in series to be integrated together, and thus a fuel cell 14 is comprised of a combination of the four power-generating cells 15 to 18.

The power-generating section 19 in the fourth power-generating cell 18 in the fuel cell 14 and the first to third power-generating cells 15 to 17 have the same structure as that of the above-mentioned power-generating cells 1 to 4 and hence, here, taking the power-generating section 19 as a representative of them, a brief description of its structure and power generation reaction is made.

The power-generating section 19 in the power-generating cells 15 to 18 has a proton conductor membrane electrode assembly 22 disposed in the middle, an oxidizer electrode-side separator 23 disposed on one side of the proton conductor membrane electrode assembly 22, a fuel electrode-side separator 24 disposed on another side of the proton conductor membrane electrode assembly 22, and two sheets of current collector electrodes 25, 26.

The proton conductor membrane electrode assembly 22 is of a three-layer structure including a proton conductor membrane disposed in the middle, and first and second catalysts formed respectively on the both surfaces of the proton conductor membrane. The proton conductor membrane is a polymer membrane exhibiting high proton (H+) conduction properties at room temperature, and, for example, a perfluorosulfonic acid film, a Nafion film (fluororesin), or the like can be used. As the first and second catalysts, for example, platinum, platinum-ruthenium, or a catalyst holding carbon powder having carried thereon platinum or the like can be used.

The fuel-side current collector electrode 25 is disposed on the first catalyst side of the proton conductor membrane electrode assembly 22, and the oxidizer-side current collector electrode 26 is disposed on the second catalyst side of the proton conductor membrane electrode assembly 22. The three-layer structure including the current collector electrode 25, the proton conductor membrane electrode assembly 22, and the current collector electrode 26 is sandwiched between the oxidizer electrode-side separator 23 and the fuel electrode-side separator 24 to constitute the power-generating section 19.

The oxidizer electrode-side separator 23 is comprised of, for example, a thin flat member, and has formed in its center portion an oxygen inlet 27 which penetrates the separator from one surface to another for introducing an oxidizer, such as oxygen or air. Between the oxidizer electrode-side separator 23 and the proton conductor membrane electrode assembly 22 is disposed the oxidizer-side current collector electrode 26 also having an oxygen inlet. Oxygen in air is introduced from the oxygen inlet 27, and the oxygen is supplied through the current collector electrode 26 to the second catalyst on the proton conductor membrane electrode assembly 22.

Similarly, the fuel electrode-side separator 24 is comprised of, for example, a thin flat member, and has in its sidewall a fuel inlet for introducing hydrogen which is a specific example of the fuel. The fuel electrode-side separator 24 has formed on the both surfaces hydrogen contact sections for bringing hydrogen into contact with the electrode. The hydrogen contact section is in communication with the fuel inlet, and hydrogen supplied from the fuel inlet is released through an internal path to the hydrogen contact sections formed respectively on the both surfaces of the fuel electrode-side separator 24. Therefore, hydrogen is supplied from the hydrogen contact section to the fuel-side current collector electrode 25 disposed between the fuel electrode-side separator 24 and the proton conductor membrane electrode assembly 22, and hydrogen is also supplied to the proton conductor 20 from the hydrogen contact section.

The fuel electrode-side separator 24 serves also as a first separator which is one separator in the proton conductor 20. It is to be noted that the first power-generating cell 15 to the third power-generating cell 17 are individually comprised solely of a power-generating portion and have no proton pump portion, and hence their fuel electrode-side separator 7 has a hydrogen contact section formed only on one surface of the separator and has a structure for preventing fuel gas leakage on another surface.

The fuel cell having the above-mentioned structure generates power, for example, as follows. Hydrogen gas as a fuel is supplied to the fuel electrode-side separator 24, and air as an oxidizer is supplied to the oxidizer electrode-side separator 23. When the hydrogen gas (H2) fuel is supplied, hydrogen (H2) is brought into contact with the catalyst on the proton conductor membrane electrode assembly 22 and electrons (e−) are freed, thus leaving protons (H+)(H2→2H++2e−). The protons (H+) move through the proton conductor membrane toward the opposite side. On the opposite side, oxygen contained in the supplied air reacts with the protons (H+) and the returned electrons (e−) due to the catalyst to form water (O2+4H++4e−→2H2O).

Next, the structure and operation of the proton conductor 20 is described. The proton conductor membrane has properties such that only protons move through the conductor, and it basically holds water (H2O) in the form of OH—H for moving protons and moves protons (H+) using —H as a footing. For this reason, the proton conductor membrane actually permits not only protons but also water to move through the conductor simultaneously. By utilizing the permeability of the proton conductor membrane to water, excess moisture inside the fuel cell can be removed from the fuel cell without using an external device, such as a pumping system, or the flow direction of moisture, the flow rate of moisture, or the like can be controlled.

The proton conductor 20 configured by using the first separator 24, has, in addition to the first separator 24, a second separator 28, a proton conductor membrane electrode assembly 29 sandwiched between the separators 24, 28, and two sheets of application electrodes 30, 31. Like the first separator 24, hydrogen gas flows through the second separator 28, to which one end of a return pipe 33 is connected. In this structure, hydrogen gas (H2) which has reached the second separator 28 is returned through the return pipe 33 to the power-generating cell on the upstream side (first power-generating cell 15 in the present embodiment).

The proton conductor membrane electrode assembly 29 may have a structure similar to that of the proton conductor membrane electrode assembly 22 in the power-generating section 19. In the present embodiment, the proton conductor membrane electrode assembly 29 has a structure similar to that of the proton conductor membrane electrode assembly 22, and it is of a three-layer structure including a proton conductor membrane disposed in the middle, and a first catalyst and a second catalyst formed respectively on the both surfaces of the proton conductor membrane. The first application electrode 30 is disposed on the side of the first catalyst, and the second application electrode 31 is disposed on the side of the second catalyst.

The three-layer structure including the first application electrode 30, the proton conductor membrane electrode assembly 29, and the second application electrode 31 is sandwiched between the first separator 24 and the second separator 28 to constitute the proton conductor 20. To the first application electrode 30 and the second application electrode 31 is connected a pump-side electric circuit 48 to make changeable the potential difference between the first application electrode 30 and the second application electrode 31. As described below, by utilizing the potential difference between the first application electrode 30 and the second application electrode 31 caused by the pump-side electric circuit 48, the proton conductor 20 can move hydrogen and moisture in the direction from the first separator 24 to the second separator 28 through the proton conductor 20, the first application electrode 30, the proton conductor membrane electrode assembly 29, and the second application electrode 31. The proton conductor 20 can also move hydrogen and moisture in the direction from the second separator 28 to the first separator 24.

The first application electrode 30 and the second application electrode 31 are electrically connected to each other in such a state that the pump-side electric circuit 48 can switch the positive electrode (+ electrode) and the negative electrode (− electrode) (that is, the direction of the voltage application is changeable). In this case, for example, when a voltage is applied so that the potential of the first application electrode 30 is higher than the potential of the second application electrode 31, hydrogen (H2) is brought into contact with the catalyst on the first gas diffusion layer, so that electrons (2e−) are freed. Simultaneously, protons (2H+), which are positive ions, are drawn to the negative side and move to pass through the proton conductor membrane electrode assembly 29.

In this instance, hydrogen (H2) supplied from the first separator 24 is wet hydrogen containing a satisfactory amount of moisture due to the back-diffused water which has passed through the three power-generating cells 15 to 17, and secures a function of carrier water for passing through the proton conductor membrane electrode assembly 29 by virtue of the moisture contained by itself. For this reason, protons (H+) on the side of the first application electrode 30 are carried by carrier water (H2O) to pass through the proton conductor membrane electrode assembly 29, so that it can easily move to the side of the second application electrode 31. Then, protons (H+) reach the second application electrode 31 where the protons react with electrons (e−) to form hydrogen (H2)(2H++2e−→H2). Subsequently, wet hydrogen (H2) containing much moisture is allowed to flow from the second separator 28 to the return pipe 33, so that the moisture content of hydrogen supplied to the power-generating section 19 can be lowered, thus changing the hydrogen in a wet state supplied to the power-generating section 19 to hydrogen having a humidity suitable for the power generation.

Conversely, when a voltage is applied so that the potential of the second application electrode 31 is higher than the potential of the first application electrode 30, protons (H+) on the side of the second application electrode 31 are carried by carrier water (H2O) to pass through the proton conductor membrane electrode assembly 29, so that it can easily move to the side of the first application electrode 30. Then, protons (H+) reach the first application electrode 30 where the protons react with electrons (e−) to form hydrogen (H2)(2H++2e−→H2). The hydrogen formed is supplied to the power-generating section 19 through the first separator 24 and used as fuel hydrogen in generating power.

When there is more moisture on the side of the second separator 28 and hydrogen on the side of the first separator 24 in communication with the power-generating section 19 is dried, hydrogen (H2) containing much moisture can be returned to the side of the first separator 24 through the proton conductor membrane electrode assembly 29, so that the moisture content of hydrogen supplied to the power-generating section 19 can be increased, thus changing the hydrogen in a dry state supplied to the power-generating section 19 to hydrogen having a humidity suitable for the power generation.

By changing the direction of the voltage applied to a portion between the first application electrode 30 and the second application electrode 31 in the proton conductor 20 using the pump-side electric circuit 48 as mentioned above, the amounts of hydrogen passing through the proton conductor 20 in one direction and in the opposite direction can be controlled to determine the humidity of the hydrogen mixed. That is, the moisture content of hydrogen moving through the proton conductor 20 in the direction from the first application electrode 30 to the second application electrode 31 is increased or, conversely, the moisture content of hydrogen moving in the direction from the second application electrode 31 to the first application electrode 30 is increased, making it possible to arbitrarily control the moisture content of hydrogen.

In this case, the proton conductor 20 is formed only in the fourth power-generating cell 18, and hence the power-generating section 19 in the fourth power-generating cell 18 is solely humidified or dehumidified. Further, the return pipe 33 is connected to the second separator 28 in communication with the proton conductor 20, and therefore the humidity of hydrogen in the proton conductor 20 is also affected by back-flow of hydrogen and moisture from the return pipe 33.

In the return pipe 33, of which one end is connected to the fuel outlet of the second separator 28, a moisture reservoir (reservoir) 34 for storing wet hydrogen or moisture discharged from the second separator 28 in the proton conductor 20 is formed. The moisture reservoir 34 may be formed either in or near the second separator 28. The moisture reservoir 34 has a drain pipe 35, and the drain pipe 35 has an on-off valve 36 at the opening. The moisture reservoir 34 is provided with a function such that the moisture condensed in the reservoir is separated from hydrogen, and water formed from the moisture condensed is released to the atmosphere by opening the on-off valve 36. The hydrogen of which the moisture has been removed by the moisture reservoir 34 to a certain extent is circulated to the fuel electrode-side separator 7 having a fuel inlet in the first power-generating cell 15.

The proton conductor 20 can pump both hydrogen and water, and the energy required for the pumping is described. One hydrogen atom (½·H2) corresponds to one proton (H+), and to 1×1.6×10-19 [C] of electrons (e−), and the one hydrogen atom generally needs 1 to 2.5 molecules of carrier water (accompanying water), and here a calculation is made on this assumption. One hydrogen molecule (H2) corresponds to two protons (H+), which is twice that for one hydrogen atom, and to 2×1.6×10-19 [C] of electrons (e−), and needs 2 to 5 molecules of carrier water.

In terms of 1 mol of hydrogen, this is corresponds to 2×6.02×1023 protons (H+), and to 2×1.6×10-19×6.02×1023 [C] of electrons (e−), and needs 2 to 5 mol of carrier water. When 1 mol of carrier water is applied to this relationship, 2×1.6×10-19×6.02×1023×½to ⅕ [C] of electrons (e−) correspond to 2×6.02×1023×½ to ⅕ protons (H+), and to 1×½ to ⅕ mol of hydrogen.

When the hydrogen flow rate per second is 10-6 mol/s (=1.34 cc/s), the amount of electrons obtained is 0.193 [A], and the amount of carrier water is 5×10-6 mol/s. In the power-generating cell 18, the hydrogen flow rate required for obtaining an electric current at 1 [A] is 7 [cc/min], and water is formed at 5.19×10-6 [mol/s] in this case. Therefore, for example, even under the worst conditions in which all the water formed is back-diffused, the proton conductor 20 can circulate all the water as carrier water for protons using an extremely low voltage at an electric current ½ to ⅕ of the generated electric current to carry humidity.

Generally, the power [W] generated by one power-generating cell is 3.0 to 3.5 W at a voltage of 0.6 to 0.7 [V] at an electric current of 5 [A] (for example, 0.6 [V]×5 [A]=3 [W]).

By contrast, the power (power consumption) required for the operation of the proton conductor 20 is 0.25 [W] at a voltage of 50 [mV] at an electric current of 5 [A] (50 [mV]×5 [A]=0.25 [W]). Therefore, when the power-generating cell is operated under conditions such that the power-generating cell consumes hydrogen at 35 [cc/min] and the proton conductor 20 circulates hydrogen at 35 [cc/min], the efficiency of the proton pump relative to the power-generating cell is as follows: efficiency=3 [W]÷0.25 [W]≅12 times.

When the power-generating cell is operated at 35 [cc/min] and hydrogen at [14 cc/min] is returned through the return pipe 33 and the driving electric current of the proton conductor 20 is 2 [A] at a voltage of 20 [mV], the power consumption is 0.04 [W] (0.02 [V]×2 [A]=0.04 [W]). Therefore, in this case, the efficiency of the proton pump relative to the power-generating cell is as follows: efficiency=3 [W]÷0.04 [W]≅80 times.

Thus, in the power-generating cell 18 and the fuel cell 14 in the present embodiment, part of the power generated by the power-generating section 19 is consumed in the proton conductor 20, but the power consumption is extremely small, as compared to the power generated (the voltage generated is 0.6 or 0.6 to 0.7 V, whereas, the voltage consumption is about 0.05 V), thus making it possible to keep efficiently generating power while rendering the lowering of the power generation efficiency as small as possible.

The fuel cell 14 having the structure shown in FIG. 1 operates, for example, as follows. The four power-generating cells 15 to 18 are connected in series through a flow path for hydrogen supplied to them. Hydrogen as a fuel is supplied in the direction from the first power-generating cell 15 to the fourth power-generating cell 18 through the second power-generating cell 16 and the third power-generating cell 17. With respect to the fuel, either hydrogen may be directly supplied or hydrogen generated by fuel reforming or the like may be used. Especially, hydrogen generated by steam reforming or the like contains much moisture, and hence there can be obtained an advantageous effect by the present invention such that a lack of moisture can be easily avoided.

When hydrogen as a fuel is supplied at the dead-end to power-generating cells 15 to 18 connected together, back-diffused water is markedly generated in the three power-generating cells 15 to 17 and the power-generating section 19 in the power-generating cell 18, and the flow of hydrogen forces the water to flow downstream, so that the partial pressure characteristics of hydrogen and water or water vapor gradually change. The change of the partial pressure characteristics has a difference between the case where the moisture is water and the case where the moisture is water vapor, but the moisture condensed into water is unlikely to flow along with the flow of hydrogen gas.

It is presumed that the electric current generated is equal in the four power-generating cells 15 to 18. When the partial pressure characteristics of water and the like under the above conditions are considered in terms of a dead-end hydrogen flow rate, the hydrogen flow rate at the downstream end 56 is 0 cc/min, and hence, when the hydrogen flow rate 52 at the first power-generating cell 15 corresponding to the upstream end is 100 cc/min, the hydrogen flow rate 53 on the supplying side of the second power-generating cell 16 is 75 cc/min, the hydrogen flow rate 54 on the supplying side of the third power-generating cell 17 is 50 cc/min, and the hydrogen flow rate 55 on the supplying side of the fourth power-generating cell 18 is 25 cc/min, and these values are considered totally ideal values.

In the above environment, the first to third power-generating cells 15 to 17 and the power-generating section 19 in the fourth power-generating cell 18 generate power, for example, as follows. Specifically, hydrogen gas as a fuel is supplied to the fuel electrode-side separator 7 or 24, and air as an oxidizer is supplied from the atmosphere to the oxidizer electrode-side separator 6 or 23. As a result, the hydrogen gas (H2) fuel is brought into contact with the first catalyst on the proton conductor membrane electrode assembly 5 or 22 and electrons (e−) are freed, so that protons are generated (H+)(H2→2H++2e−).

The protons (H+) pass through the proton conductor membrane in the proton conductor membrane electrode assembly 5 or 22 toward the second catalyst on the opposite side. At the second catalyst, oxygen contained in the air supplied reacts with the protons (H+) and the returned electrons (e−) due to the catalyst, thereby form water (O2+4H++4e−→2H2O).

This chemical reaction successively forms water at the oxidizer electrode-side separator 6 or 23 on the proton conductor membrane electrode assembly 5 or 22. The diffusion process of the water and back-diffused water is carried out similarly in the four power-generating cells 15 to 18, but the content of moisture in the hydrogen supplied to the power-generating cell on the downstream side is larger than the content of moisture back-diffused in the hydrogen supplied to the power-generating cell on the upstream side. As hydrogen moves downstream, the back-diffused water is forced to flow, so that the water is successively stored in the fourth power-generating cell 18. Therefore, hydrogen containing much moisture formed in the power-generating section 19 in the fourth power-generating cell 18 is discharged from the proton conductor 20 and returned to the return pipe 33.

In this case, the pump-side electric circuit 48 for the proton conductor 20 applies a voltage so that the potential of the first application electrode 30 is higher than the potential of the second application electrode 31. As a result, hydrogen (H2) supplied from the first separator 24 is brought into contact with the first catalyst and electrons (e−) are freed, so that protons (H+) move through the proton conducting membrane in the direction from the first catalyst to the second catalyst.

In this instance, hydrogen (H2) supplied from the first separator 24 is wet hydrogen having a humidity increased by absorbing moisture when passing through the three power-generating cells 15 to 17 on the upstream side, and the hydrogen itself contains a satisfactory amount of moisture. For this reason, this hydrogen (H2) secures a function of carrier water required for moving itself. Therefore, protons (H+) generated at the first catalyst can easily pass through the proton conducting membrane and move toward the second catalyst.

Further, protons (H+) reach the second catalyst where the protons react with electrons (e−) to form hydrogen (H2)(2H++2e−→H2), thus forming hydrogen (H2) containing much moisture. Then, the wet hydrogen containing much moisture is circulated from the second separator 28 to return pipe 33. The wet hydrogen circulated to the return pipe 33 is temporarily stored in the moisture reservoir 34, and part of the wet hydrogen is satisfactorily increased in moisture to be condensed, and the rest, of which the moisture is removed, is converted to hydrogen having an appropriate humidity.

The hydrogen having an appropriate humidity is returned to the first power-generating cell 15, and mixed with another dry hydrogen and then used again in the power generation. By repeating this cycle, not only does the fuel cell 14 continue generating power, but also hydrogen containing a satisfactory amount of moisture can be discharged from the power-generating cell 18 on the downstream side, thus securing practice of the power generation.

The action of the fuel cell is described here with respect to a number of power-generating cells connected in series, but this applies to a single power-generating cell. That is, the upstream portion and the downstream portion as viewed in the direction of the hydrogen gas flow can be similarly applied to a single power-generating cell.

FIG. 2 shows a device used for confirming the principle of the fourth power-generating cell 18 shown in FIG. 1, showing a schematic structure of an assembled power-generating cell and a piping structure. A hydrogen flow path 40 is connected to the fuel electrode-side separator (first separator) 24, and the hydrogen flow path 40 has a pressure gauge 41 which detects a pressure of hydrogen supplied. The hydrogen supplied to the hydrogen flow path 40 is so-called dry hydrogen containing no moisture or a little moisture. Air from the atmosphere is supplied to the oxidizer electrode-side separator 23 from the oxygen inlet 27.

Further, one end of the return pipe 33 is connected to the second separator 28, and another end is connected to the pressure gauge 41 on the downstream side in the hydrogen flow path 40. At the return pipe 33, a hygrometer 43, a pressure gauge 44, a flow meter 45, and a check valve 46 are arranged in the order from the second separator 28. The hygrometer 43 measures a humidity of hydrogen returned from the second separator 28 to the hydrogen flow path 40. The pressure gauge 44 measures a pressure in the return pipe 33, i.e., pressure of hydrogen returned from the second separator 28 to the hydrogen flow path 40.

The flow meter 45 measures a flow rate of hydrogen flowing the return pipe 33. The check valve 46 prevents hydrogen from flowing in the direction from the hydrogen flow path 40 to the return pipe 33. The pressure of hydrogen in the return pipe 33 is generally equivalent to or higher than the pressure of hydrogen in the hydrogen flow path 40, and therefore the hydrogen in the return pipe is mixed with the dry hydrogen in the hydrogen flow path 40 and then recirculated.

The pressure gauge 41, hygrometer 43, pressure gauge 44, flow meter 45, and check valve 46 are merely used for confirming the principle of the proton pump. The positions and arrangement of the pressure gauge 41 and others are not limited to those in the present embodiment. Further, the pressure gauge 41 and others are used if necessary when the apparatus is practically used, and they can be omitted when they are not necessary.

A power generation-side electric circuit 47 is formed at the power-generating section 19 in the power-generating cell 18. In the power generation-side electric circuit 47 is generated an electric current flowing in a clockwise direction in FIG. 2, i.e., in the direction from the fuel electrode-side separator 24 to the oxidizer electrode-side separator 23 through the proton conductor membrane electrode assembly 22. A pump-side electric circuit 48 is formed at the proton conductor 20 in the power-generating cell 18. To the pump-side electric circuit 48 is applied an electric current flowing in a counter-clockwise direction in FIG. 2, i.e., in the direction from the second separator 24 to the second separator 28 through the proton conductor membrane electrode assembly 29.

The pump-side electric circuit 48 is provided for applying an appropriate voltage to a portion between the first application electrode 30 and the second application electrode 31 in the proton conductor 20. Further, the pump-side electric circuit 48 is provided with a variable power source 49 which can change the voltage applied and the direction of the voltage application. The pump-side electric circuit 48 generally applies a voltage so that the potential of the first application electrode 30 is higher than the potential of the second application electrode 31. This causes a pumping action in the proton conductor 20, making it possible to return the wet hydrogen containing much moisture to the return pipe 33.

Conversely, when a voltage is applied so that the potential of the first application electrode 30 is lower than the potential of the second application electrode 31, wet hydrogen containing much moisture moves in the direction from the second separator 28 to the first separator 24. As a result, the wet hydrogen containing much moisture is supplied from the first separator 24 to the power-generating section 19, so that the moisture is effectively used in the power-generating section 19 for generating power and the like (e.g., role of carrier water).

FIG. 3 shows an embodiment of a modification of the circuit structure in FIG. 2, and, in FIG. 2 and FIG. 3, like parts or portions are indicated by like reference numerals. In the present embodiment, a bypass pipe 50 is formed instead of the return pipe 33, and one end of the bypass pipe 50 is connected to the second separator 28 and another end is connected to the first separator 24. At the bypass pipe 50, a pressure gauge 44, a hygrometer 43, and a flow meter 45 are arranged in the order from the second separator 28, and a check valve is omitted. The positions and arrangement of the pressure gauge 44 and others are not limited to those in this embodiment, and a check valve may be provided. This connected structure can achieve an effect similar to that obtained in the embodiment of FIG. 2.

FIGS. 17A and 17B are graphs for explaining the relationship between the hydrogen humidity and the hydrogen flow path. In FIG. 17A, reference numeral 57 indicates a conventional humidity distribution in which the hydrogen density decreases linearly in the direction from the upstream portion to the downstream portion in the hydrogen flow path. Reference numeral 58 indicates a range in which humidification or dehumidification is performed to the conventional humidity distribution of hydrogen by controlling the humidity. In this case, there is a relative difference in hydrogen humidity between the upstream portion and the downstream portion in the hydrogen flow path and this is not preferred, and therefore, as indicated by reference numeral 59, the humidity gradient is averaged by the humidity circulation.

FIG. 17B shows a range of the humidity distribution (reference numeral 60) of the hydrogen humidity averaged (reference numeral 59), which is obtained by controlling the hydrogen humidity as in the present embodiment and averaging the humidity gradient by the humidity circulation. By averaging the humidity of hydrogen in this way, it is possible to keep efficiently generating power while rendering the lowering of the power generation efficiency as small as possible.

In addition, in the present invention, the proton conductor 20 is generally difficult to operate when the proton conductor membrane is dried (in a dry state such that moisture lacks), but the circulation of hydrogen is needed when the hydrogen flow path is blocked by water, and therefore the blocking water secures satisfactory humidity required for operating the proton pump. Further, by providing the power-generating section 19 and the proton conductor 20 so that they are close to each other as in the present embodiment, the humidity of hydrogen flowing toward the power-generating section 19 and the humidity of hydrogen flowing toward the proton conductor 20 can be kept at the similar level.

Therefore, by observing the internal resistance (=voltage applied/electric current) of the proton conductor 20, the humidity of the whole hydrogen electrode (fuel electrode) can be sensed at the same time, thus offering a function of a humidity sensor. Further, as mentioned above, by reversing the direction of the voltage between a pair of gas diffusion layers, the pump direction can be reversed to move the hydrogen having a higher humidity in the opposite direction. In addition, the pump rate (pump speed) can be arbitrarily selected by adjusting the hydrogen flow rate, and, by matching the area of the proton pump, the voltage applied, the electric current, the material for the proton conductor membrane, and the like, the pump efficiency can be increased and optimized.

Further, the proton pump can not only move protons through the proton conductor membrane but also promote the movement of carrier water (namely, can move both hydrogen and moisture). Therefore, the humidity of hydrogen as a fuel can be controlled to be suitable for the power generation, making it possible to prevent the power generation reaction from lowering due to the excessive drying or sinking of the proton conductor in the power-generating portion. Further, with respect to the movement of moisture, the effect of dehumidification or humidification can be obtained depending on the site of the proton pump used. Further, with respect to the movement of hydrogen, the proton pump can control the pressure or flow rate, and serves also as a vacuum regulator, a pressurizing compressor, or a flow controller. In addition, the pressure gradient caused in this instance can make the one-way circulation flow to prevent back-flow of hydrogen.

As the fuel gas, either hydrogen gas comprised solely of pure hydrogen or hydrogen mixed gas containing hydrogen as a component (e.g., methane, methanol, propane, butane, or gasoline) may be used. Specifically, a method in which hydrogen is directly supplied using a gas cylinder, a liquid hydrogen tank, an alloy having hydrogen occluded therein, or the like, a method in which hydrogen-rich reformate gas obtained by reforming an existing hydrocarbon fuel, such as natural gas (methane) or methanol, is supplied, or the like may be used. Supplying of oxygen is similar, and a method in which air is supplied or a method in which oxygen is directly supplied can be used.

FIG. 4 shows the fuel cell in the second embodiment of the present invention, and a fuel cell 62 in the present embodiment has a structure such that additional dry hydrogen 63 is supplied to the moisture reservoir 34 in the first embodiment to control the state of hydrogen in the return pipe 33. The structure except for this is similar to that shown in FIG. 1, and hence like parts or portions are indicated by like reference numerals and their descriptions are omitted. In the present embodiment, it is shown that the return pipe 33 is connected as a pipe using a tubular member like in the above embodiment, but the connection is not limited to a connection through a pipe, and it is of course included another structure, for example, a connection such that the separators are bonded together to form a return pipe path, or the like may be employed.

According to the second embodiment, dry hydrogen having an appropriate humidity preliminarily given by wet hydrogen is supplied to a fuel inlet of the first power-generating cell 15 among the four power-generating cells 15 to 18. For this reason, hydrogen having a humidity substantially averaged can be allowed to flow through the hydrogen flow path for the four power-generating cells 15 to 18 connected in series.

FIG. 5 shows the fuel cell in the third embodiment of the present invention, and, in a fuel cell 64 in the present embodiment, instead of the first power-generating cell 15 in the second embodiment, a first power-generating cell 15A having a structure similar to that of the fourth power-generating cell 18 is provided, and a proton conductor 20 is also provided in the power-generating cell positioned on the most upstream side. The first power-generating cell 15A has a structure similar to that of the fourth power-generating cell 18, and one end of the return pipe 33 is connected to the first power-generating cell 15A. The structure of the fuel cell 64 except for this is similar to that in the second embodiment shown in FIG. 4, and hence like parts or portions are indicated by like reference numerals and their descriptions are omitted.

In the third embodiment, wet hydrogen discharged from the proton conductor 20 in the fourth power-generating cell 18 is supplied to the moisture reservoir 34, and the hydrogen is mixed with additional dry hydrogen 63 supplied to the moisture reservoir 34. The hydrogen having a humidity appropriately controlled after the mixing is supplied to the second separator 28 in the proton conductor 20 in the first power-generating cell 15A. The hydrogen supplied from the second separator 28 is used in the above-mentioned pumping action when passing through the proton conductor 20. Then, part of the hydrogen which has passed through the proton conductor 20 moves to the power-generating section 19 and is used in the above-mentioned power generation action.

On the other hand, the rest of the hydrogen which has passed through the proton conductor 20, excluding the hydrogen consumed at the power-generating section 19, moves in the direction from the first separator 24 to the second power-generating cell 16. Part of this hydrogen is used in the power generation at the second power-generating cell 16, and the rest is supplied to the third power-generating cell 17. Further, part of the hydrogen supplied to the third power-generating cell 17 is used in the power generation, and the rest is supplied to the fourth power-generating cell 18. Then, in the fourth power-generating cell 18, the power generation by the power-generating section 19 and the pumping action by the proton conductor 20 are carried out as mentioned above.

The moisture reservoir 34 in FIG. 5 may have a structure such that it is formed inside the first power-generating cell 15A or inside the fourth power-generating cell 18. Alternatively, a structure may be employed such that the four power-generating cells 15A and 16 to 18, which are integrated, have the moisture reservoir 34 incorporated thereinto.

FIG. 6 is a view for explaining a principle of the fuel cell in the embodiment of the present invention. A fuel cell 65 has an oxidizer electrode-side separator 66, a fuel electrode-side separator 67, and a third separator 68 which are stacked on one another, a power-generating portion 69, and a proton conductor 70 which is a specific example of the hydrogen gas humidity control apparatus. The oxidizer electrode-side separator 66 and the fuel electrode-side separator 67 are stacked through the power-generating portion 69, and a space portion formed in the separators 66, 67 is partitioned by the power-generating portion 69 into an oxidizer-side gas diffusion chamber 71 and a fuel-side gas diffusion chamber 72. The third separator 68 is stacked on the outside of the fuel electrode-side separator 67, and to form in the separators 67, 68 a hydrogen gas chamber 73 which is a specific example of the second hydrogen flow path or hydrogen chamber through which hydrogen gas is supplied.

Further, the oxidizer electrode-side separator 66 has an oxygen inlet 74, and the oxygen inlet 74 is in communication with the oxidizer-side gas diffusion chamber 71. Through the oxygen inlet 74 is supplied air from the/atmosphere (particularly oxygen) or oxygen from an oxygen tank. The fuel electrode-side separator 69 has a fuel inlet 75, and the fuel inlet 75 is in communication with the fuel-side gas diffusion chamber 72. To the fuel inlet 75 is connected a fuel source, such as a hydrogen tank, and a fuel (particularly hydrogen) is supplied from the fuel source. The third separator 68 has a hydrogen inlet 76, and the hydrogen inlet 76 is in communication with the hydrogen gas chamber 73. To the hydrogen inlet 76 is connected the hydrogen tank, e.g., a fuel source, or a hydrogen source separately provided, and hydrogen is supplied from the hydrogen source.

As a material for the oxidizer electrode-side separator 66, fuel electrode-side separator 67, and third separator 68, for example, either a non-conductor, such as ceramic or a plastic, or a conductor, such as an aluminum alloy, a stainless steel alloy, or a carbon material, can be used. In the embodiment shown in FIG. 6, each of the three separators is formed from a conductive material, and, in this case, it is preferred that insulating sealing members 77 are disposed, respectively, between the oxidizer electrode-side separator 66 and the fuel electrode-side separator 67 and between the fuel electrode-side separator 67 and the third separator 68.

The power-generating portion 69 of the fuel cell 65 has a proton conductor membrane 78 for power generation held between the oxidizer electrode-side separator 66 and the fuel electrode-side separator 67, and a pair of catalyst layers 79, 80 formed respectively on the both surfaces of the proton conductor membrane 78. As a material for the catalyst layers 79, 80, for example, a catalyst, such as platinum or platinum-ruthenium, can be used. The oxidizer-side gas diffusion chamber 71 surrounding the catalyst layer 79 corresponds to a gas diffusion layer on the oxidizer side, and the fuel-side gas diffusion chamber 72 surrounding the catalyst layer 80 corresponds to a gas diffusion layer on the fuel electrode side. As a material for the gas diffusion layers, for example, carbon cloth, carbon paper, or the like can be used.

The fuel electrode-side separator 67 has an opening portion 83 in communication with the fuel-side gas diffusion chamber 72 and the hydrogen gas chamber 73. To the opening portion 83 is attached the proton conductor 70, and the moisture carrier or proton conductor partitions the opening portion 83 to separate the fuel-side gas diffusion chamber 72, which is the first hydrogen flow path or hydrogen chamber, from the hydrogen gas chamber 73, which is the second hydrogen flow path or hydrogen chamber. In the embodiment shown in FIG. 6, the proton conductor 70 separates the fuel-side gas diffusion chamber 72 from the hydrogen gas chamber 73.

The proton conductor 70 has a structure similar to that of the power-generating portion 69, and has a proton conductor membrane 84 which is a polymer electrolyte membrane, and a first catalyst 85 and a second catalyst 86 formed respectively on the both surfaces of the proton conductor membrane 84. Further, a first voltage application electrode is formed on the surface of the first catalyst 85 facing the fuel-side gas diffusion chamber 72, and a second voltage application electrode is formed on the surface of the second catalyst 86 facing the hydrogen gas chamber 73. The direction of the voltage between the first and second voltage application electrodes can be selectively changed. Therefore, the voltage applied to the first voltage application electrode can be higher than the voltage applied to the second voltage application electrode or, conversely, the voltage applied to the second voltage application electrode can be higher than the voltage applied to the first voltage application electrode.

The proton conductor membrane 84 is fixed to the inside of the fuel electrode-side separator 67 so as to seal the entire opening portion 83 up. Thus, the first catalyst 85 disposed on one surface of the proton conductor membrane 84 faces the fuel-side gas diffusion chamber (first hydrogen flow path or hydrogen chamber) 72 to which fuel gas used for generating power is supplied, and the second catalyst 86 disposed on another surface of the proton conductor membrane 84 faces the hydrogen gas chamber (second hydrogen flow path or hydrogen chamber) 73 to which fuel gas used for carrying moisture is supplied.

The operation of the fuel cell 65 having the above structure is, for example, outlined below. In FIG. 6, fuel gas is supplied from the hydrogen inlet 76 of the fuel cell 65 and air is supplied from the oxygen inlet 74. In this case, when the oxygen inlet 74 is exposed to the atmosphere, air is automatically supplied from the atmosphere. Therefore, at the anode in the fuel electrode-side separator 67, hydrogen (H2) is divided into protons (H+) and electrons (e−and, at the cathode in the oxidizer electrode-side separator 66, oxygen (O2) combines with protons (H+), which have moved through the proton conductor membrane 78, and electrons (e−), which have traveled through an external circuit, so that electrons (e−) generated at the power-generating portion 69 are taken out in the form of power.

In this instance, at the cathode in the power-generating portion 69, oxygen (O2) combines with the protons (H+) and electrons (e−) to form water (4H++4e−→2H2+O2=2H2O). The water generated in the power-generating portion 69 is back-diffused through the catalyst layer 79 on the side of the oxidizer electrode-side separator 66 and the proton conductor membrane 78 and back-diffused to the catalyst layer 80 on the side of the fuel electrode-side separator 67. Then, moisture passes through the catalyst layer 80 and appears on the surface on the side of the fuel electrode-side separator 67 to evaporate into hydrogen in the fuel-side gas diffusion chamber 72, so that the humidity in the fuel-side gas diffusion chamber 72 is higher, permitting the moisture to move through the gas diffusion layer to the proton conductor 70.

The moisture which has reached the proton conductor 70 goes into the proton conductor from the first catalyst 85, and passes through the proton conductor membrane 84 to the second catalyst 86 on the other side. In this case, by changing the direction of the voltage between the both surfaces of the proton conductor membrane 84, the direction of the movement of moisture (H2O) and protons (H+) can be changed. Specifically, as shown in the figure, when the potential of the electrode on the side of the first catalyst of the proton conductor membrane 84 is higher than the potential of the electrode on the side of the second catalyst, the moisture (H2O) and protons (H+) move in the direction from the first catalyst 85 (+ electrode) to the first catalyst 86 (− electrode). In this instance, the humidity on the side of the power-generating portion 69 is lower, so that the fuel gas tends to be dried.

Conversely, when the potential of the electrode on the side of the second catalyst of the proton conductor membrane 84 is higher than the potential of the electrode on the side of the first catalyst, the moisture (H2O) and protons (H+) move in the direction from the second catalyst 86 as a + electrode to the first catalyst 85 as a − electrode. In this instance, the humidity on the side of the power-generating portion 69 is higher, so that the fuel gas tends to be wetted. Accordingly, by controlling the direction of the voltage application to the proton conductor membrane 84, the direction of the movement of moisture and protons can be changed to control the humidity of fuel gas in the power-generating portion 69.

By using a moisture carrier instead of the proton conductor membrane 84, the humidity of fuel gas can be controlled. In this case, no voltage is applied to the moisture carrier, but the humidity is controlled using natural diffusion caused by the humidity difference to move the moisture. The moisture carrier does not absorb moisture in contact with its surface to hold the moisture, but it moves the moisture in the direction from the higher humidity to the lower humidity to discharge the moisture from the opposite side. For example, when the humidity in the fuel-side gas diffusion chamber 72 is higher than the humidity in the hydrogen gas chamber 73, the moisture goes into the hydrogen gas chamber through the moisture carrier. When the amount of the moisture going into the hydrogen gas chamber exceeds a predetermined amount, the moisture is condensed into water drops and, for example, discharged from the hydrogen gas chamber 73 or used for controlling the moisture in another power-generating cell.

By virtue of the repeated control of the humidity of hydrogen by the proton conductor 70 (or moisture carrier), even when water is continuously formed in the power-generating portion 69, not only can the humidity of hydrogen in the power-generating portion 69 be controlled to supplying fuel gas having the optimal humidity for the power generation to the power-generating portion 69, but also excess moisture can be removed from the power-generating portion 69.

Thus, in the fuel cell 65 in the present embodiment, because the proton conductor 70 (or moisture carrier) is provided on the side of the fuel electrode-side separator 67, it can keep the humidity in the fuel cell 65 during the power generation constant at an appropriate level, thus enabling the power-generating portion 69 to continue generating power always under the optimal conditions.

FIG. 7 is an explanatory view showing another specific example of the structure of the fuel cell 65 shown in FIG. 6. In FIG. 7 and FIG. 6, like parts or portions are indicated by like reference numerals. FIG. 8 shows a fuel cell 88 which is an example of a modification on the fuel cell 65 shown in FIG. 7.

The fuel cell 65 of FIG. 7 and the fuel cell 88 shown in FIG. 8 individually has a number of power-generating portions and one (or a pair of) proton conductor(s) 70. A plurality of oxidizer electrode-side separators 66 having the above-described structure and the same number of fuel electrode-side separators 67 are alternately stacked on one another, and a third separator 68 is stacked on one surface of the outermost fuel electrode-side separator 67.

In the fuel cell 88 shown in FIG. 8, the separator laminate is kept in a laterally faced state and placed on one proton conductor 70. The proton conductor 70 is placed on the fourth separator 89. Hydrogen as a fuel is vertically supplied to the horizontal separator laminate, and air is horizontally supplied to the separator laminate. The excess moisture which has been used for generating power in the power-generating portion is discharged in the direction from the bottom of the proton conductor 70 to the side. This structure can achieve an effect similar to that obtained by the above embodiment.

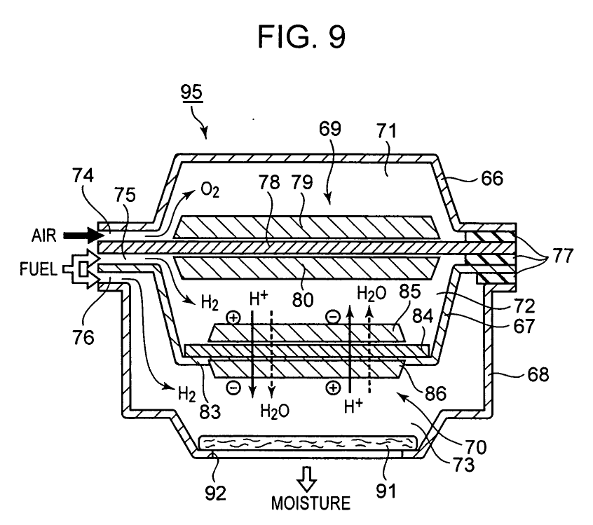

FIG. 9 is a cross-sectional view showing the structure of a fuel cell 95 which is an example of a modification on the fuel cell 65 shown in FIG. 6. The fuel cell 95 has a power-generating portion 69, a proton conductor 70, and a moisture carrier 91. Specifically, the fuel cell 95 has an oxidizer electrode-side separator 66, a fuel electrode-side separator 67, and a third separator 68 which are stacked on one another, a proton conductor membrane 84 which is a polymer electrolyte membrane for the proton conductor 70, and a moisture carrier 91 which is a specific example of the moisture carrier.

The moisture carrier 91 moves moisture using natural diffusion caused by the humidity difference, and it does not absorb moisture in contact with its surface to hold the moisture, but it moves the moisture toward the lower humidity to discharge the moisture from the opposite side. The moisture carrier 91 may be attached to the inside of the fuel electrode-side separator 69. As the moisture carrier 91, for example, a perfluorosulfonic acid film or a Nafion film (fluororesin), which is a proton conducting membrane, porous ceramic, or the like can be used.

The oxidizer electrode-side separator 66, the fuel electrode-side separator 67, the power-generating portion 69 disposed between the separators 66, 67, the moisture carrier 91 attached to the third separator 68, and sealing members 77 for sealing the proton conductor membrane 78 of the power-generating portion 69 and the oxidizer electrode-side separator 66 and the fuel electrode-side separator 67 are respectively similar to those in the fuel cell 65 of FIG. 6. The oxidizer electrode-side separator 66 has an oxygen inlet 74, and the fuel electrode-side separator 67 has a hydrogen inlet 76.

Further, the proton conductor 70 is provided at the inner opening portion 83 which is a moisture outlet for the fuel electrode-side separator 67. The proton conductor 70 has a structure similar to that in the power-generating portion 69, and has the proton conducting membrane 84 which is a polymer electrolyte membrane, and a first catalyst 85 and a second catalyst 86 formed respectively on the both surfaces of the proton conductor membrane 84. The proton conductor membrane 84 is attached to the inside of the fuel electrode-side separator 67 so as to seal the inner opening portion 83 up, and the first catalyst 85 disposed on one surface of the proton conductor membrane faces the gas diffusion layer 72 to which fuel gas used for generating power is supplied, and the second catalyst 86 disposed on another surface of the proton conductor membrane faces the hydrogen gas chamber 73 to which fuel gas used for carrying moisture is supplied.

The third separator 68 is stacked through the sealing member 77 on the fuel electrode-side separator 67, and the three separators form together a three-layer structure. The third separator 68 has an outer opening portion 92 which is a moisture outlet. The moisture carrier 91 is attached to the inner wall of the third separator 68 by a bonding means, such as an adhesive or pressing, so as to seal the outer opening portion 92 up. In the side portion of the third separator 68 is formed the hydrogen inlet 76 for introducing a fuel for carrying the moisture which has passed through the proton conductor 70 to go into the side of the third separator 68.

In the fuel cell 95 having the above structure, the power generation reaction and the reaction of moisture by the proton conductor 70 similar to those described above with reference to FIG. 6 are conducted, and, by controlling the direction of the voltage applied to the proton conductor 70, the direction of the movement of moisture and protons can be changed to control the humidity of fuel gas in the power-generating portion 69.

When the humidity of the catalyst layer 86 of the proton conductor 70 is higher and hence the humidity in the hydrogen gas chamber 73 surrounded by the third separator 68 is higher, the moisture goes into the moisture carrier 91. Then, when the humidity in the moisture carrier 91 is increased to a certain extent, moisture appears on the surface in contact with the outside air, and, when the amount of the moisture on the surface exceeds a predetermined amount, the moisture is condensed into water drops and discharged therefrom.

The moisture which has reached the moisture carrier 91 goes into the moisture carrier and appears on the other surface to be brought into contact with the outside air. The humidity of the outside air in contact with the moisture carrier 91 is lower than the humidity in the third separator 68, and therefore the moisture contained in the moisture carrier 91 is released to the outside air. By virtue of the repeated conduction of the moisture in the proton conductor 70 and moisture carrier 91, even when water is continuously formed in the power-generating portion 69, not only can the humidity be controlled to supply fuel gas having the optimal humidity to the power-generating portion 69, but also excess moisture can be discharged to the outside.

Thus, in the fuel cell 95 in the present embodiment, the proton conductor 70 and moisture carrier 91 provided on the side of the fuel electrode-side separator 67 can discharge the moisture formed in the fuel cell 65 during the power generation from the fuel electrode-side separator 69 to keep the humidity in the fuel cell 95 during the power generation constant at an appropriate level, enabling the fuel cell to continue generating power always under the optimal conditions.

FIGS. 10A to 16B show other embodiments of the above-described power-generating cell having a combination of the power-generating portion and the proton conductor. The power-generating cell of FIG. 10A has substantially the same structure as that of the fourth power-generating cell 18 shown in FIG. 1, and corresponds to the embodiment in which oxygen is introduced to the oxidizer electrode-side separator 23 by an air open method. A power-generating cell 100 has a power-generating section 19 and a proton conductor 20.

A fuel electrode-side separator 24 is in communication with a third separator 28 via a hydrogen pipe 120 through which hydrogen flows, and hydrogen can be supplied from either of the separators 24, 28 to the other. In the third separator 28 and hydrogen pipe 120, a moisture absorbing material can be used, or it may have a structure which can discharge hydrogen, such as a moisture condensation trap.

FIG. 10B shows an embodiment of a modification on the power-generating cell 100 shown in FIG. 10A, in which oxygen is introduced to the oxidizer electrode by an air pressure supplying method. A power-generating cell 101 has a power-generating section 19A having an oxidizer electrode-side separator 121. In the inner wall of the oxidizer electrode-side separator 121 are formed a number of communication channels 122 through which air (oxygen) is pneumatically supplied. The structure except for this is similar to that of the power-generating cell 100.

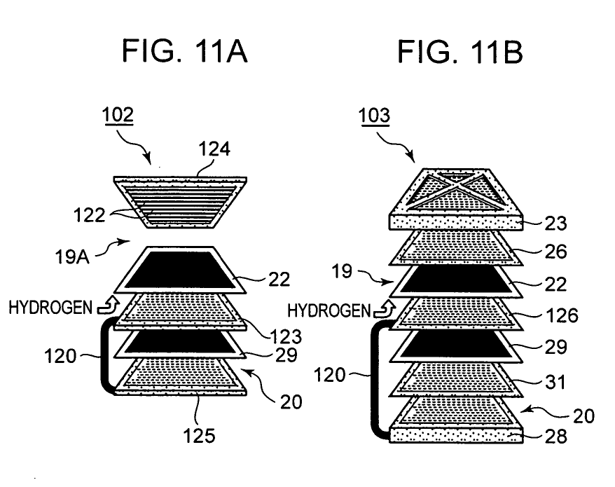

A power-generating cell 102 shown in FIG. 11A is similar to the power-generating cell 101 shown in FIG. 10B except that the electrodes 25, 30 are stacked on the top and bottom of the fuel electrode-side separator 24 and integrated together to constitute a fuel electrode-side separator 123, the current collector electrode 26 is integrated with the oxidizer electrode-side separator 121 to constitute an oxidizer electrode-side separator 124, and the electrode 31 is integrated with the third separator 28 to constitute a third separator 125. Thus, the separators 123, 124, 125 individually serve as electrodes, enabling current collection or application of a voltage through the separators 123, 124, 125.

Further, the fuel electrode-side separator 123 and the third separator 125 are suitable for an air pressure supplying method according to the function of the oxidizer electrode-side separator 124. The fuel electrode-side separator 123 of the proton conductor 20 is in communication with the third separator 125 through the hydrogen pipe 120, and hence hydrogen can be allowed to flow between the separators 123, 125. In the present embodiment, the number of parts constituting the power-generating cell can be reduced, thus making it possible to lower the thickness or size of the apparatus.

A power-generating cell 103 shown in FIG. 11B is similar to the power-generating cell 100 shown in FIG. 10A except that the electrodes 25, 30 are stacked on the top and bottom of the fuel electrode-side separator 24 and integrated together to constitute a current collector 126, and thus the power-generating cell 103 has a simplified structure. The current collector 126 is in communication with the third separator 28 through the hydrogen pipe 120. In the present embodiment, hydrogen as fuel gas is supplied from the current collector 126 and the third separator 28 to the power-generating section 19 and the proton conductor 20.

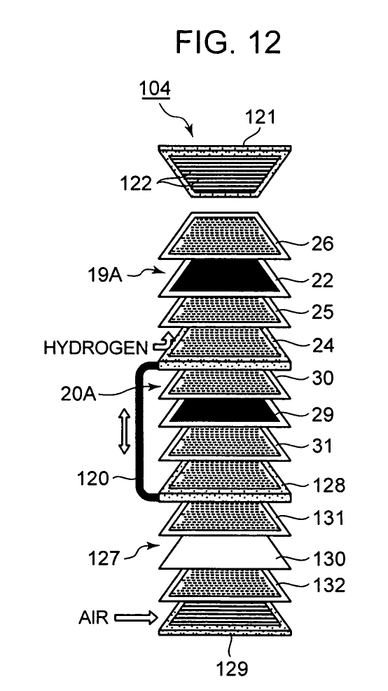

In a power-generating cell 104 shown in FIG. 12, the humidity of fuel gas supplied to a power-generating section 19A is controlled by two hydrogen gas humidity control apparatuses, i.e., a proton conductor 20A and a moisture carrier 127. The proton conductor 20A is disposed under the power-generating section 19A, and the moisture carrier 127 is disposed under the proton conductor. In the power-generating cell 104, the humidity in a proton conductor membrane electrode assembly 22 in the power-generating section 19A is controlled by the proton conductor 20A, and the humidity in the proton conductor 20A is controlled by the moisture carrier 127.

Further, the proton conductor 20A has a fuel electrode-side separator 24 which serves also as a fuel electrode-side separator for the power-generating section 19A, a third separator 128, a proton conductor membrane electrode assembly 29 disposed between the separators 24, 128, and electrodes 30, 31 disposed respectively on the top and bottom of the proton conductor membrane electrode assembly. The fuel electrode-side separator 24 is in communication with the third separator 128 through the hydrogen pipe 120 and hydrogen gas can flow between them.

The moisture carrier 127 has the third separator 128 in the proton conductor 20A, a fourth separator 129 to which air is supplied, a moisture carrier 130 disposed between the separators 128, 129, and porous plates 131, 132 disposed respectively on the top and bottom of the moisture carrier. The moisture carrier 130 has no catalyst and hence a current collector effect is not needed, and therefore the porous plates 131, 132 may be omitted.

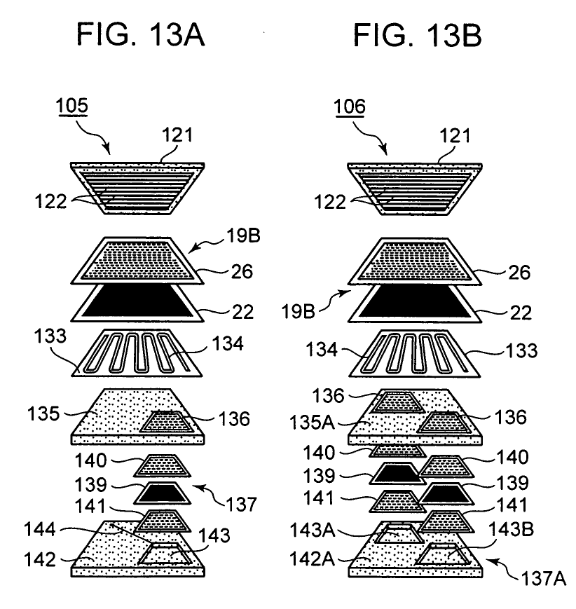

Power-generating cells 105, 106, 107, 108, 109, 110, 111, and 112 shown in FIGS. 13A to 16B individually have a structure such that the ratio of the total area of the proton conductor membrane electrode assemblies 139 of the proton conductors 137, 137A, 137B, 138 to the area of the proton conductor membrane electrode assembly 22 in the power-generating portions 19A, 19B is small.

A power-generating cell 105 shown in FIG. 13A is comprised of a power-generating section 19B and a proton conductor 137. The power-generating section 19B is comprised of an oxidizer electrode-side separator 121, a fuel electrode-side separator 135, a proton conductor membrane electrode assembly 22, a current collector electrode 26 sandwiched between the oxidizer electrode-side separator 121 and the proton conductor membrane electrode assembly 22, and an electrode 133 sandwiched between the proton conductor membrane electrode assembly 22 and the fuel electrode-side separator 135. In the electrode 133, a communication channel 134 extending in a waveform for developing hydrogen is formed in the entire surface of the catalyst layer of the proton conductor membrane electrode assembly 22.

The proton conductor 137 has the fuel electrode-side separator 135 and a third separator 142, and one small-size proton conductor 137 is formed between the separators 135, 142. The proton conductor 137 is comprised of a proton conductor membrane electrode assembly 139, and electrodes 140, 141 disposed respectively on the both surfaces of the proton conductor membrane electrode assembly. The area of the proton conductor membrane electrode assembly 139 is considerably small, as compared to the area of the proton conductor membrane electrode assembly 22 in the power-generating section 19B.

Thus, when the size of the proton conductor 137 is small, as compared to the size of the power-generating section 19B, the humidity of hydrogen gas in the power-generating section 19B can be controlled. Especially when the proton conductor 137 is small in size, the humidity in an arbitrary portion of the power-generating section 19B can be controlled in a concentrated manner. Therefore, the present embodiment has an advantage in that, for example, when one power-generating section 19B has a large difference in humidity between the upstream side and the downstream side, the humidity on the higher (or lower) side can be controlled in a concentrated manner.

Further, the proton conductor 137 has the proton conductor membrane electrode assembly 139 having a size sufficient for the proton pump capacity, and the proton conductor membrane electrode assembly 139 is comprised of a proton conducting membrane disposed in the middle, and catalyst layers formed respectively on the top and bottom surfaces of the proton conducting membrane. A hydrogen inlet 136 having a size corresponding to the size of the proton conductor membrane electrode assembly 139 is formed in the separator 135 on the side of the fuel electrode, and a container recess portion 143 having the similar size is formed in the third separator 142. In each of the separators 135, 142, a hydrogen flow path is communication with the hydrogen inlet 136 or container recess portion 143 is formed.

The third separator 142 has a check valve 144 for preventing the hydrogen having a higher humidity pumped by the proton conductor 137 from back-flowing. In the present embodiment, the pumping action can be made using a small-size proton conductor, thus suppressing the lowering of the power generation efficiency. The check valve 144 may be omitted.

A power-generating cell 106 shown in FIG. 13B is such that the humidity of hydrogen gas is controlled using two proton pumps in which the proton conductor membrane electrode assembly 139 of the proton conductor 137A is considerably small, as compared to the proton conductor membrane electrode assembly 22 in the power-generating section 19B. A difference between the power-generating cell 106 shown in the present embodiment and the power-generating cell 105 shown in FIG. 13A resides in that two proton conductor membrane electrode assemblies 139 are used, and consequently two hydrogen inlets 136, 136 are formed in the fuel electrode-side separator 135A and two container recess portions 143A, 143B are formed in the third separator 142A. The structure except for this is similar to that in the above embodiment.

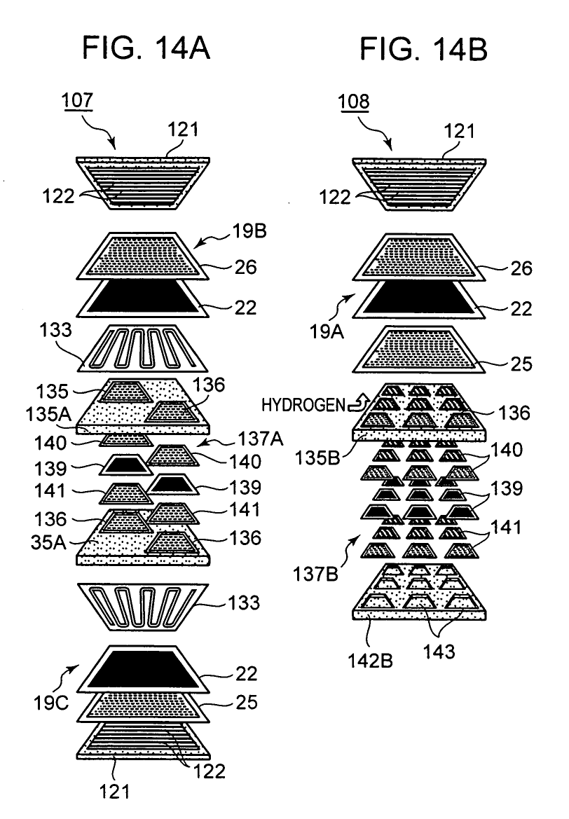

A power-generating cell 107 shown in FIG. 14A corresponds to an embodiment such that a lower power-generating section 19C is formed under the power-generating cell 106 shown in FIG. 13B. The lower power-generating section 19C has a structure similar to that of the upper power-generating section 19B, but the order of the stacked layers is opposite, and the upper power-generating section 19B is disposed upside down under the fuel electrode-side separator 135A. In the present embodiment, the two upper and lower power-generating portions 19B, 19C are disposed so as to face each other through the hydrogen supplying side in the middle, and therefore the oxidizer-side electrodes can be disposed so as to face each other similarly. Accordingly, there is an advantage in that oxygen is supplied from the both sides of hydrogen to keep the temperature of the hydrogen electrode, preventing the hydrogen electrode from suffering moisture condensation.

A power-generating cell 108 shown in FIG. 14B corresponds to an embodiment such that a number of proton conductors are formed in the proton conductor 137B in the power-generating cell 106 shown in FIG. 13B. Accordingly, the same numbers of hydrogen inlets 136 are formed in the fuel electrode-side separator 135B, and the same number of container recess portions 143 are formed in the third separator 142B. In the present embodiment, the hydrogen circulation path to the power-generating section 19A can be arbitrarily switched, so that the humidity of an arbitrary side in the power-generating section 19A can be independently controlled (dehumidified or humidified). Further, the upstream, midstream, and downstream portions in the hydrogen flow path can be displaced.

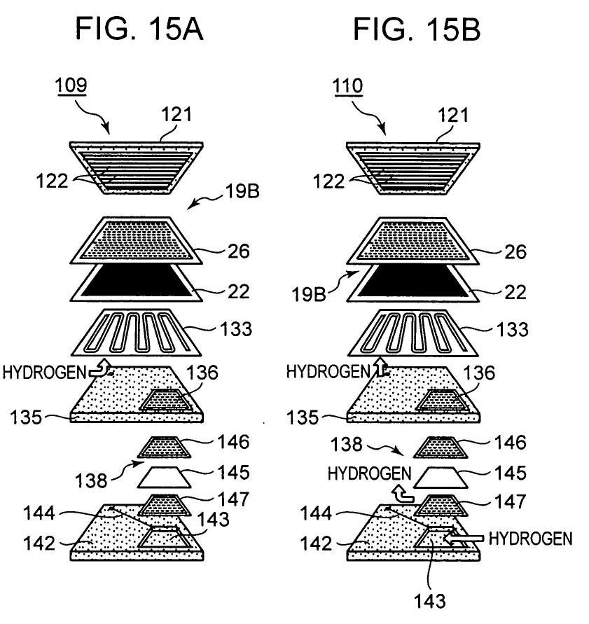

Power-generating cells 109, 110 shown in FIGS. 15A and 15B are embodiments of modifications on the power-generating cell 106 shown in FIG. 13A, and use a moisture carrier as the hydrogen gas humidity control apparatus. The moisture carrier is comprised of, for example, a proton conductor membrane 145 having no catalyst, and porous plates 146, 147 respectively disposed on the both surfaces of the proton conductor membrane 145. The structure except for this is similar to that of the power-generating cell 106 in the embodiment shown in FIG. 13A, and hence their descriptions are omitted. FIG. 15A shows the case where hydrogen is supplied from the fuel electrode-side separator 135 to the power-generating section 19B. FIG. 15B shows the case where hydrogen is supplied from the third separator 142 to the proton conductor membrane 145, and further supplied through the fuel electrode-side separator 135 to the power-generating section 19B.

In the embodiment shown in FIG. 15A, moisture can be moved by natural diffusion of the moisture using a small-size moisture carrier. Therefore, power generated in the power-generating section 19B is not used for controlling the moisture, making it possible to prevent the lowering of the power generation efficiency. In the embodiment shown in FIG. 15B, hydrogen is supplied to the small-size moisture carrier to forcibly diffuse moisture, so that the moisture can positively move. Further, in the examples shown in FIGS. 15A and 15B, no catalyst is used and hence no electric current is applied, leading to an advantage in that no current collector is needed to simplify the structure.

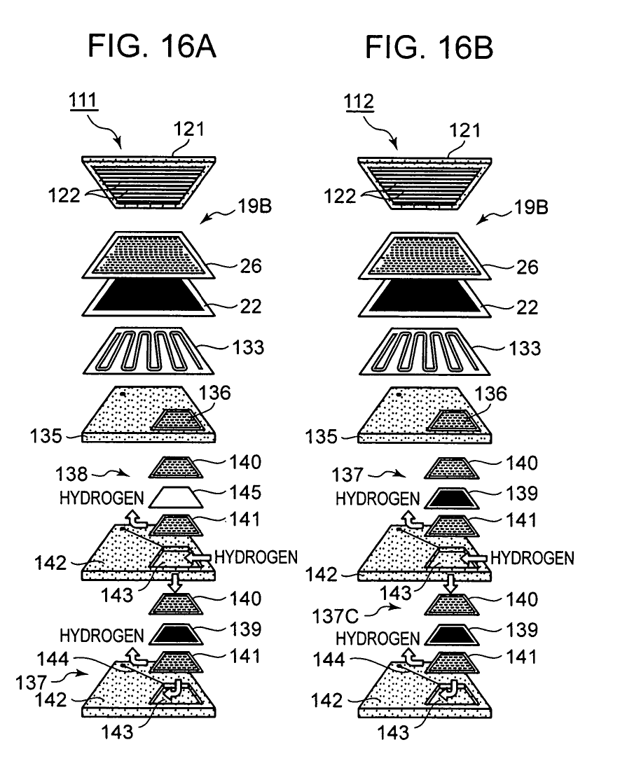

A power-generating cell 111 shown in FIG. 16A is an embodiment of a modification on the power-generating cell 110 shown in FIG. 15B. Specifically, under the moisture carrier 138 in the power-generating cell 110 is disposed the above-mentioned proton conductor 137 and they are laminated together to constitute the power-generating cell 111. A power-generating cell 112 shown in FIG. 16B is an embodiment of a modification on the power-generating cell 105 shown in FIG. 13A. Specifically, under the proton conductor 137 in the power-generating cell 105 is disposed a second proton conductor 137C having a similar structure and they are laminated together to constitute the power-generating cell 112.

In these embodiments, the circulation of hydrogen and humidity in the power-generating section 19B is controlled using the upper moisture carrier 138 or proton conductor 137, and an increase or reduction of the humidity of hydrogen is controlled using the lower proton conductor 137 or proton conductor 137C. The structure except for this is similar to that of the above embodiment shown in the figure, and hence their descriptions are omitted. Further, in the embodiments shown in FIGS. 10A to 16B, the actions of the power-generating portion and the proton conductor and moisture carrier are similar to those mentioned with reference to FIG. 1 and the like, and hence their descriptions are omitted.

The fuel cell in the 14th embodiment of the present invention divides hydrogen (H2) into protons (2H+) and electrons (2e−) at the anode, and takes part of the generated electrons out in the form of power. In this instance, at the cathode, oxygen (O2) combines with protons, which have moved through an electrolyte membrane, and electrons, which have traveled through an external circuit, to form water as a by-product.

For making protons to move through the proton conducting membrane used in the fuel cell, water is needed, and therefore the by-produced water is diffused in inside the diffusion electrode and positively utilized for improving the proton conductivity. On the other hand, if water by-produced excessively generated in the diffusion electrode, it inhibits oxygen from moving, thus inhibiting the fuel cell from generating power. Therefore, for allowing the fuel cell to continue stably generating power, it is essential to keep the moisture content of the proton conducting membrane constant in a predetermined range.

The humidity control method in a fuel cell of the present invention controls the humidity of fuel gas (particularly hydrogen) used in the fuel cell, and a moisture carrier which is permeable to water and/or water vapor and which is impermeable to the fuel gas is used. A brief description of the moisture carrier is made below.

The moisture carrier is used for moving an object using natural diffusion caused by the humidity difference, and the object which the moisture carrier moves is moisture. The amount of the moisture which moves through the moisture carrier can be controlled by, for example, changing the flow rate of air or the humidity or temperature of air.

As the fuel gas, either hydrogen gas comprised solely of pure hydrogen or hydrogen mixed gas containing hydrogen as a component (e.g., methane, methanol, propane, butane, or gasoline) may be used. Specifically, a method in which hydrogen is directly supplied using a gas cylinder, a liquid hydrogen tank, an alloy having hydrogen occluded therein, or the like, a method in which hydrogen-rich reformate gas obtained by reforming an existing hydrocarbon fuel, such as natural gas (methane) or methanol, is supplied, or the like may be used. Supplying of oxygen is similar, and a method in which air is supplied or a method in which oxygen is directly supplied can be used.

FIG. 18 is a view for explaining a principle of the fuel cell in the embodiment of the present invention. In the present embodiment, a fuel cell 265 is comprised of a power-generating portion 266 and a moisture carrier 267. Specifically, the fuel cell 265 is comprised of an oxidizer electrode-side separator 268 and a fuel electrode-side separator 269 which are stacked on each other, a proton conducting membrane 270 which is a polymer electrolyte membrane for the power-generating portion 266, and a moisture carrier 267.

The oxidizer electrode-side separator 268 and the fuel electrode-side separator 269 are comprised of members which are stacked to form therebetween a space portion having an appropriate capacity, and the proton conducting membrane 270 for the power-generating portion 266 is held in the space portion. As a material for the separators 268, 269, for example, either a non-conductor, such as ceramic or a plastic, or a conductor, such as an aluminum alloy, a stainless steel alloy, or a carbon material, can be used. In the embodiment shown in FIG. 18, each of the oxidizer electrode-side separator 268 and the fuel electrode-side separator 269 is formed from a conductive material, and, in this case, it is preferred that insulating sealing members 272 are disposed, respectively, between the separators 268, 269 and the proton conducting membrane 270.

The oxidizer electrode-side separator 268 disposed on the upper side has an oxygen inlet 273 for introducing air. The fuel electrode-side separator 269 disposed on the lower side has a hydrogen inlet 274 for introducing a fuel. Further, in the substantially central portion of the fuel electrode-side separator 269 is formed a moisture outlet 275 for discharging the moisture generated in the fuel cell 265 therefrom. A proton conducting membrane as the moisture carrier 267 is attached to the outer wall of the fuel electrode-side separator 269 by a bonding means, such as an adhesive or pressing, so as to cover the moisture outlet 275.

The moisture carrier 267 moves moisture using natural diffusion caused by the humidity difference, and has a function such that it does not absorb moisture in contact with its surface to hold the moisture, but it moves the moisture toward the lower humidity side to discharge the moisture from the opposite side. The moisture carrier 267 may be attached to the inside of the fuel electrode-side separator 269. As the moisture carrier 267, for example, a perfluorosulfonic acid film or a Nafion film (fluororesin), which is a proton conducting membrane, porous ceramic, or the like can be used.

A catalyst layer 276 and a catalyst layer 277 are formed respectively on the both surfaces of the proton conducting membrane 270 in the power-generating portion 266, that is, the catalyst layer 276 is formed on the side of the oxidizer electrode-side separator 268, and the catalyst layer 277 is formed on the side of the fuel electrode-side separator 269. As a material for the catalyst layers 276, 277, for example, a catalyst, such as platinum or platinum-ruthenium, can be used. Further, gas diffusion layers 278, 279 are formed to surround the catalyst layers 276, 277, respectively. As a material for the gas diffusion layers 278, 279, for example, carbon cloth, carbon paper, or the like can be used.

FIG. 19 is an explanatory view showing the schematic structure of an embodiment of the fuel cell 265 shown in FIG. 18, and, in FIG. 19 and FIG. 18, like parts or portions are indicated by like reference numerals. The fuel cell 265 has a third separator 280 in addition to the above-mentioned two separators 268, 269, and a proton conducting membrane as the moisture carrier 267 sandwiched between the third separator 280 and the fuel electrode-side separator 269.

Further, the third separator 280 has an air inlet 281 for introducing air for carrying the moisture which has passed through the moisture carrier 267 to appear on the side of the third separator 280. The air for carrying moisture introduced from the air inlet 281 flows through a supplying path 282 between the third separator 280 and the moisture carrier 267 and then is discharged.

In FIG. 19, reference numeral 283 indicates a sealing member for sealing a portion between the fuel electrode-side separator 269 and the third separator 280. Reference numeral 284 indicates reinforcement members formed on the both surfaces of the moisture carrier 267. The reinforcement 284 is made of, for example, a porous material, such as netted gauze, and is used for controlling the amount of the moisture carried or controlling the gap between the moisture carrier 267 and the third separator 280 caused due to the use of the sealing member 283.

The operation of the fuel cell 265 having the above structure is, for example, described below. In FIG. 18, in the fuel cell 265, a fuel is supplied from the hydrogen inlet 274 to the fuel electrode-side separator 269 on the anode side, and air is supplied from the oxygen inlet 273 to the oxidizer electrode-side separator 268 on the cathode side. Thus, at the anode, hydrogen (H2) is divided into protons (2H+) and electrons (2e−), and, at the cathode, oxygen (O2) combines with protons (2H+), which have moved through the proton conducting membrane 270, and electrons (2e−), which have traveled through an external circuit, so that part of the electrons (2e−) generated in the power-generating portion 266 are taken out in the form of power.

In this instance, in the inside of the oxidizer electrode-side separator 268 in the power-generating portion 266, oxygen (O2) combines with the protons (2H+) and electrons (2e−) to form water (4H++4e−→2H2+O2=2H2O). The water generated in the power-generating portion 266 passes through the catalyst layer 276 on the side of the oxidizer electrode-side separator 268 and the proton conducting membrane 270 and is back-diffused to the catalyst layer 277 on the side of the fuel electrode-side separator 269. Then, the water passes through the catalyst layer 277 to appear on the surface on the side of the fuel electrode-side separator 269, so that the humidity in the fuel electrode-side separator 269 is higher, permitting the moisture to move through the gas diffusion layer 279 to the moisture carrier 267. In this case, the moisture to be discharged may be water in a liquid state, or it is of course in a water vapor.

The moisture which has reached the moisture carrier 267 goes into the moisture carrier and appears on the other surface to be brought into contact with the outside air. The humidity of the outside air in contact with the moisture carrier 267 is lower than the humidity in the fuel electrode-side separator 269, and therefore the moisture contained in the moisture carrier 267 is released to the outside air. By virtue of the repeated conduction of the moisture, even when water is continuously formed in the power-generating portion 266, the water can be continuously discharged to the outside. Therefore, by forming the moisture outlet 275 in the fuel electrode-side separator 269 and providing the moisture carrier 267, the moisture formed in the fuel cell 265 during the power generation is discharged from the side of the fuel electrode-side separator 269, making it possible to keep the humidity in the fuel cell 265 constant at an appropriate level.

In this case, in the embodiment of FIG. 19, the moisture which has reached the moisture carrier 267 passes through the moisture carrier to the side of the third separator 280 and is released to air for carrying moisture, which is discharged gas. Then, the moisture is carried by the air for carrying moisture supplied from the air inlet 281 and flows through a flow path formed in the third separator 280 and is carried away from the fuel cell. Therefore, the moisture formed in the fuel cell 265 during the power generation is discharged from the fuel cell, making it possible to keep the humidity in the fuel cell 265 constant at an appropriate level.

FIG. 20 is an explanatory view showing the schematic structure of an example of the fuel cell 265 in the embodiment shown in FIGS. 18 and 19 having a two-layer structure. In FIG. 20, like parts or portions in FIG. 18 and FIG. 19 are indicated by like reference numerals, and their descriptions are omitted. The fuel cell 265 has two intermediate separators 294, 295 in addition to the above-described two separators 268, 269, 287. The first intermediate separator 294 serves also as an oxidizer electrode-side separator and is disposed under the fuel electrode-side separator 269, and the second intermediate separator 295 is disposed under the first intermediate separator 294. The second intermediate separator 295 serves also as a fuel electrode-side separator, and the third separator 287 is disposed under the second intermediate separator 295.

The first power-generating portion 266 is disposed between the oxidizer electrode-side separator 268 and the fuel electrode-side separator 269, and the first moisture carrier 267 is disposed between the fuel electrode-side separator 269 and the first intermediate separator 294. Further, the second power-generating portion 296 is disposed between the first intermediate separator 294 and the second intermediate separator 295, and the second moisture carrier 297 is disposed between the second intermediate separator 295 and the third separator 287. In the first intermediate separator 294 is formed a combination inlet 298 for introducing air which serves as both oxygen for generating power and air for carrying moisture. The second intermediate separator 295 has a second hydrogen inlet 299 for introducing hydrogen as fuel gas into the second power-generating portion 296.

The second power-generating portion 296 has a structure similar to that of the first power-generating portion 266, and the second moisture carrier 297 has a structure similar to that of the first moisture carrier 267. However, the structures of the first power-generating portion 266 and the second power-generating portion 296 may of course be different, and the structures of the first moisture carrier 267 and the second moisture carrier 297 may of course be different. As a material for the first and second intermediate separators 294, 295, like the fuel electrode-side separator 269 and the like, for example, either a non-conductor, such as ceramic or a plastic, or a conductor, such as an aluminum alloy or a stainless steel alloy, can of course be used.

The operation of the fuel cell 265 having a multilayer structure shown in FIG. 20 in which a plurality of power-generating portions and moisture carriers are stacked on one another is described below. The operation of generating power in each of the first power-generating portion 266 and the second power-generating portion 296 is similar to that described above with reference to FIG. 20, and power is generated individually in the power-generating portions 266 and 296, and the power individually generated is collected through an electric circuit and taken out.

In this case, the humidity of the air for generating power and for carrying moisture, which is supplied from the combination inlet 298, is lower than the humidity in the fuel electrode-side separator 269, and therefore excess moisture generated in the first power-generating portion 266 is carried due to the first moisture carrier 267 toward the first intermediate separator 294. The moisture is released by the first moisture carrier 267 to air on the side of the first intermediate separator 294, and flows through a flow path formed in the first intermediate separator 294 and is removed from the power-generating portion. Therefore, the moisture formed in the first power-generating portion 266 during the power generation is removed from the power-generating portion, making it possible to keep the humidity in the first power-generating portion 266 constant at an appropriate level.

Further, the humidity of the air for carrying moisture supplied from the air inlet 293 is lower than the humidity in the second intermediate separator 295, and therefore excess moisture generated in the second power-generating portion 296 is carried due to the second moisture carrier 297 toward the third separator 287. The moisture is released by the second moisture carrier 297 to air on the side of the third separator 287, and flows through a flow path formed in the third separator 287 and is discharged to the outside. Therefore, the moisture formed in the second power-generating portion 296 during the power generation is discharged to the outside, making it possible to keep the humidity in the second power-generating portion 296 constant at an appropriate level.

In FIGS. 18 to 20, examples are shown in which the moisture carrier 267 or the second moisture carrier 297 is formed at a position adjacent to the power-generating portion 266 or the second power-generating portion in the fuel cell, but they may be formed at a position far from the power-generating portion and attached onto the fuel flow path through which fuel gas flows so that they are in contact with air for carrying moisture. When the moisture carrier 267 or the second moisture carrier 297 moves moisture between the fuel gas and the air for carrying moisture, the moisture formed in the power-generating portion during the power generation is released to the outside, making it possible to keep the humidity in the power-generating portion constant at an appropriate level.

Next, a test made using a test model prepared based on the embodiment shown in FIG. 20 is described. This test employs a passive mechanism in which the moisture on the hydrogen side is controlled using a moisture carrier. The structure of the test model is schematically shown in FIG. 20, and a Nafion film was used in the two moisture carriers.

The moisture formed in the power-generating portion in the test model moves through a Nafion film so as to balance the humidity in the power-generating portion with the humidity of the outside air, and therefore no water is collected in the hydrogen supplying zone. The Nafion film and the second power-generating portion are stacked on one another and an air supplying path is formed therebetween to constitute a stacked structure in which air is commonly supplied. When the end portions of all the fuel supplying paths and air supplying paths in the test model are closed to create a mechanism in which the fuel and air are pneumatically supplied using a pump, the amount of the carried moisture on the hydrogen side and that on the air side can be independently controlled, thus enabling a more precise humidity control.

In the Example of FIG. 20, a structure may of course be employed such that an opening portion is formed in the third separator 287 and moisture is discharged to the outside through the moisture carrier 267 covering the opening portion. Further, the number of the stacked power-generating portions and moisture carriers constituting one fuel cell is not limited to the number in the present embodiment, but an appropriate number, e.g., three or more power-generating portions and moisture carriers can be stacked.

FIG. 21 is a graph showing the output characteristics obtained from the test model, wherein a cell voltage (V) is taken as the ordinate, and a time (sec) is taken as the abscissa. As a polymer electrolyte membrane electrode assembly (MEA) for the power-generating portion and moisture carrier, one sheet having a size of 22.5 cm2 was used. Conditions for the test were such that an electric current at 3 A (amperes) was continuously flowed while cooling by means of an air fan to keep substantially room temperature. FIG. 21 shows the following results.

In FIG. 21, a change of the voltage from point t1 to point t2 (about 250 sec) immediately after the start of operation is caused due to the changing at the set-up of electronic devices, parts, and the like until their performance is stabilized. A fall of the voltage from t3 point (about 1,500 sec) to point t4 is the changing of the voltage caused by adjusting the conditions for measurement, and this range is outside of the measuring region in this test. A constant voltage output (about 0.62 V) can be obtained generally over the measuring region (from point t2 to point t3, and from point t4 to point t5), excluding the non-measuring region (from point t3 to point t4).

FIG. 22 is a graph showing the relationship between a cell voltage and an internal resistance measured in the last about 2 hours in the continuous operation at an electric current of 4 A for 8 hours. This test was conducted with respect to each of the first power-generating cell (V11, R1) and the second power-generating cell (V12, R2). From the voltage (V)-resistance (Ω) graph, in the first power-generating cell, the voltage output (V11) was about 0.640 V, and the internal resistance (R1) was about 0.0170 (Ω). In the second power-generating cell, the voltage output (V12) was about 0.634 V, and the internal resistance (R2) was about 0.0180 (Ω).

As is apparent from the results, the deviation of voltage is ±1 mV, and that of resistance is within 0.1 mΩ, which confirms that a stable operation can be maintained. There was no need to purge hydrogen during the operation, and an unfavorable phenomenon, such as moisture condensation in the fuel supplying path or the like, or a lack of the fuel, did not occur.

FIG. 23 is a graph showing the relationship between an electric current (A) and a voltage (V) in the above test. This test was conducted twice with respect to each of the first power-generating cell and the second power-generating cell. From the graph of the I-V (current-voltage) characteristics, it has been confirmed that, in each of the first power-generating cell {indicated by symbols ● (solid circles) and ◯ (open circles)} and the second power-generating cell {indicated by symbols ▪ (solid squares) and □ (open squares)}, an electric current of up to about 7 amperes (A) can be output without any problem.

As can be seen from FIGS. 21 to 23, by virtue of the moisture carrier which is in contact with the fuel gas and the discharged gas to move moisture between the fuel gas and the discharged gas, when the fuel gas has a humidity higher than that of the discharged gas, moisture moves in the direction from the fuel gas to the discharged gas, and, when the fuel gas has a humidity lower than that of the discharged gas, moisture moves in the direction from the discharged gas to the fuel gas. Therefore, even when moisture formed due to the power generation in the fuel cell causes the humidity to be unsuitable for power generation of the power-generating cell, the movement of moisture between the discharged gas and the fuel gas is repeated, making it possible to keep the humidity in the fuel cell constant at an appropriate level, so that the power generation advantageously continues.

Hereinabove, the present invention is described, but the present invention is not limited to the above embodiment, and, for example, the method for supplying oxygen as an oxidizer is not limited to the above-described air open method or air pressure supplying method. The present invention can be varied or modified as long as it is not deviated from the effect aimed at by the present invention.

As described above, in the hydrogen gas humidity control apparatus according to an embodiment of the present application, the first hydrogen flow path or hydrogen chamber and the second hydrogen flow path or hydrogen chamber are separated by the moisture carrier, and therefore, when the contents of water and/or water vapor in the two hydrogen flow paths or hydrogen chambers are different, the water and/or water vapor moves through the moisture carrier in the direction from the higher content to the lower content. Thus, there can be obtained an effect such that the humidity of hydrogen can be controlled so that the contents of water and/or water vapor in the two hydrogen flow paths or hydrogen chambers are the same.

In the hydrogen gas humidity control apparatus according to an embodiment of the present application, the hydrogen gas is hydrogen gas generated by fuel reforming, and hydrogen generated by steam reforming or the like contains much moisture, and hence there can be obtained an advantageous effect such that a lack of moisture is easily avoided.

In the hydrogen gas humidity control apparatus according to an embodiment of the present application, the first hydrogen flow path or hydrogen chamber and the second hydrogen flow path or hydrogen chamber are separated by the proton conductor, and therefore, when the contents of water and/or water vapor in the two hydrogen flow paths or hydrogen chambers are different, the water and/or water vapor moves through the proton conductor in the direction from the higher content to the lower content or from the lower content to the higher content. Even when the contents are the same, the water and/or water vapor moves through the proton conductor from one side to another. Thus, there can be obtained an effect such that the humidity of hydrogen can be arbitrarily controlled so that the contents of water and/or water vapor in the two hydrogen flow paths or hydrogen chambers are the same or arbitrarily selected.

In the hydrogen gas humidity control apparatus according to an embodiment of the present application, a catalyst is disposed on at least one surface of the proton conductor selected from the surface facing the first hydrogen flow path or hydrogen chamber and the surface facing the second hydrogen flow path or hydrogen chamber, and therefore there can be obtained an effect such that the catalyst can divide hydrogen into protons or convert protons to hydrogen.

In the hydrogen gas humidity control apparatus according to an embodiment of the present application, a first voltage application electrode is provided to the first hydrogen flow path or hydrogen chamber, a second voltage application electrode is provided to the second hydrogen flow path or hydrogen chamber, and the proton conductor is sandwiched between the electrodes, and hence they can constitute a proton pump to control the humidity of hydrogen gas. Therefore, there can be obtained an effect such that the apparatus can be used as a humidifier or dehumidifier for keeping optimal the humidity of hydrogen in the hydrogen flow path or hydrogen chamber, a humidity sensor, a vacuum regulator, a pressurizing compressor, a flow controller, or the like.

In the hydrogen gas humidity control apparatus according to an embodiment of the present application, by virtue of the structure in which a voltage is applied to a portion between the first voltage application electrode and the second voltage application electrode, there can be obtained an effect such that protons can be moved through the proton conductor in the direction from the higher voltage to the lower voltage.

In the hydrogen gas humidity control apparatus according to an embodiment of the present application, by virtue of the structure in which platinum is used as the catalyst, there can be obtained an effect such that hydrogen can be efficiently divided into protons, or protons can be efficiently converted to hydrogen.

In the hydrogen gas humidity control apparatus according to an embodiment of the present application, the hydrogen gas is hydrogen gas generated by fuel reforming, and hydrogen generated by steam reforming or the like contains much moisture, and hence there can be obtained an advantageous effect such that a lack of moisture is easily avoided.

In the fuel cell according to an embodiment of the present application, which includes: at least one or two or more power-generating cell having a fuel electrode-side separator, an oxidizer electrode-side separator, and a proton conductor membrane electrode assembly; and a hydrogen gas humidity control apparatus; wherein a moisture carrier is sandwiched between a first substrate and a second substrate in the hydrogen gas humidity control apparatus, and mixed gas of hydrogen and water and/or water vapor is in contact with the first substrate and at least hydrogen is in contact with the second substrate. Therefore, there can be obtained an effect such that, when the humidity of hydrogen in the hydrogen flow path or hydrogen chamber through which the fuel is supplied is high, the hydrogen is dehumidified by permitting excess water and/or water vapor to pass through the moisture carrier toward the side of lower humidity, or, when the humidity of hydrogen in the hydrogen flow path or hydrogen chamber is low, the hydrogen is humidified by introducing water and/or water vapor from the side of higher humidity through the moisture carrier, thus making it possible to keep efficiently generating power.

In the fuel cell according to an embodiment of the present application, which includes: at least one or two or more power-generating cell having a fuel electrode-side separator, an oxidizer electrode-side separator, and a proton conductor membrane electrode assembly; and a hydrogen gas humidity control apparatus; wherein a proton conductor is sandwiched between a first electrode and a second electrode in the hydrogen gas humidity control apparatus, and mixed gas of hydrogen and water and/or water vapor is in contact with the first electrode and at least hydrogen is in contact with the second electrode. Therefore, there can be obtained an effect such that, by applying a voltage to a portion between the electrodes, water and/or water vapor can be moved in the direction from the higher voltage to the lower voltage, and, by controlling the direction of the voltage application, the humidity of hydrogen in the two hydrogen flow paths or hydrogen chambers is adjusted, thus making it possible to keep efficiently generating power.

In the humidity control method of hydrogen gas according to an embodiment of the present application, by holding the proton conductor by sandwiching between a first electrode and a second electrode and applying a voltage to a portion between the first electrode and the second electrode, moisture is carried between the hydrogen, which is supplied to the fuel electrode in a fuel cell and in contact with the first electrode, and the hydrogen, which has a humidity different from that of the hydrogen in contact with the first electrode and is in contact with the second electrode, and therefore water and/or water vapor can be moved in the direction from the higher voltage to the lower voltage, and, by controlling the direction of the voltage application, the humidity of hydrogen in the two hydrogen flow paths or hydrogen chambers is adjusted, thus making it possible to keep efficiently generating power in the fuel cell.

By virtue of the moisture carrier which is in contact with the fuel gas and the discharged gas to move moisture between the fuel gas and the discharged gas, when the fuel gas has a humidity higher than that of the discharged gas, moisture moves in the direction from the fuel gas to the discharged gas, and, when the fuel gas has a humidity lower than that of the discharged gas, moisture moves in the direction from the discharged gas to the fuel gas. Therefore, even when moisture formed due to the power generation in the fuel cell causes the humidity to be unsuitable for power generation of the power-generating cell, the movement of moisture between the discharged gas and the fuel gas is repeated, thus making it possible to keep the humidity in the fuel cell constant at an appropriate level. The humidity in the fuel cell can be kept constant at an appropriate level, and hence the power-generating portion can be prevented from being dried or wetted to an excess extent, so that the power generation advantageously continues.

The fuel cell may have a discharge flow path through which discharged gas flows, and the discharged gas containing oxygen may be supplied to the oxygen electrode side of the fuel cell. When the fuel cell has the discharge flow path through which the discharged gas flows, air from the outside of the fuel cell is supplied as the discharged gas to the discharge flow path to effectively put the discharged gas into contact with the moisture carrier, thus making it easy to keep the humidity in the fuel cell constant at an appropriate level. When the discharged gas containing oxygen is supplied to the oxygen electrode side of the fuel cell, the fuel cell can generate power using the discharged gas, thus enabling power generation effectively utilizing the discharged gas.

When the moisture carrier contains a perfluorosulfonic acid polymer, the moisture carrier can surely and easily carry moisture.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-19. (canceled)

20. A hydrogen gas humidity control apparatus, comprising:
a first hydrogen flow path or chamber thereof to which at least hydrogen gas is supplied;
a second hydrogen flow path or chamber thereof to which at least hydrogen gas is supplied; and
a moisture carrier for separating the first hydrogen flow path or chamber thereof from the second hydrogen flow path or chamber thereof and for allowing at least one of water and water vapor to pass therethrough.

21. The hydrogen gas humidity control apparatus according to claim 20, wherein
the hydrogen gas is hydrogen gas generated by fuel reforming.

22. A hydrogen gas humidity control apparatus, comprising:
a first hydrogen flow path or chamber thereof to which at least hydrogen gas is supplied;
a second hydrogen flow path or chamber thereof to which at least hydrogen gas is supplied; and
a proton conductor for separating the first hydrogen flow path or chamber thereof from the second hydrogen flow path or chamber thereof.

23. The hydrogen gas humidity control apparatus according to claim 22, wherein
the proton conductor has a catalyst disposed on at least one surface of the proton conductor selected from a surface facing the first hydrogen flow path or chamber thereof and a surface facing the second hydrogen flow path or chamber thereof.

24. The hydrogen gas humidity control apparatus according to claim 22, further comprising:
a first voltage application electrode associated with the first hydrogen flow path or hydrogen chamber;
a second voltage application electrode associated with the second hydrogen flow path or hydrogen chamber; and
the proton conductor is sandwiched between the first voltage application electrode and the second voltage application electrode.

25. The hydrogen gas humidity control apparatus according to claim 22, wherein
a voltage is applied to a portion between the first voltage application electrode and the second voltage application electrode.

26. The hydrogen gas humidity control apparatus according to claim 23, wherein
the catalyst contains platinum.

27. The hydrogen gas humidity control apparatus according to claim 22, wherein
the hydrogen gas is hydrogen gas generated by fuel reforming.

28. A fuel cell, comprising:
at least one power-generating cell having
a fuel electrode-side separator to which a fuel is supplied,
an oxidizer electrode-side separator to which an oxidizer is supplied, and
a proton conductor membrane electrode assembly sandwiched between the fuel electrode-side separator and the oxidizer electrode-side separator; and
at least one hydrogen gas humidity control apparatus, which is incorporated to at least one of a hydrogen flow path and a hydrogen chamber to which the fuel is supplied;
wherein the hydrogen gas humidity control apparatus having
a first substrate,
a second substrate, and
a moisture carrier sandwiched between the first substrate and the second substrate;
wherein a mixed gas of at least one of hydrogen and water and water vapor is in contact with the first substrate and at least hydrogen is in contact with the second substrate.

29. A fuel cell, comprising:
one or more power-generating cell having
a fuel electrode-side separator to which a fuel is supplied,
an oxidizer electrode-side separator to which an oxidizer is supplied, and
a proton conductor membrane electrode assembly sandwiched between the fuel electrode-side separator and the oxidizer electrode-side separator; and
at least one hydrogen gas humidity control apparatus, which is incorporated to a hydrogen flow path and/or hydrogen chamber to which the fuel is supplied;
wherein the hydrogen gas humidity control apparatus having
a first electrode,
a second electrode, and
a proton conductor sandwiched between the first electrode and the second electrode;
wherein a mixed gas of at least one of hydrogen and water and water vapor is in contact with the first electrode and at least hydrogen is in contact with the second electrode.

30. A hydrogen gas humidity control method, comprising:
holding a proton conductor by sandwiching between a first electrode and a second electrode; and
applying a voltage to a portion between the first electrode and the second electrode wherein an amount of moisture is carried between hydrogen supplied from a fuel electrode of a fuel cell and hydrogen in contact with the second electrode and having a humidity different from that of the hydrogen in contact with the first electrode.

31. A fuel cell, comprising
a power-generating cell having an electrolyte sandwiched between a fuel electrode and an oxygen electrode;
an oxygen electrode-side separator having formed therein an oxygen flow path through which oxygen is supplied to the oxygen electrode;
a fuel electrode-side separator having formed therein a fuel flow path through which fuel gas is supplied to the fuel electrode; and
a moisture carrier disposed in contact with the fuel gas and in contact with discharged gas having a humidity different from that of the fuel gas to carry moisture between the fuel gas and the discharged gas.

32. The fuel cell according to claim 31, comprising a discharge flow path through which discharged gas flows.

33. The fuel cell according to claim 31, wherein
the fuel cell has a plurality of the power-generating cells;
the moisture carrier is disposed between a first power-generating and a second power-generating; and
the discharged gas in contact with the moisture carrier contains oxygen and is supplied to the second power-generating cell.

34. The fuel cell according to claim 31, wherein the moisture carrier contains a perfluorosulfonic acid polymer.

35. The fuel cell according to claim 31, wherein air existing outside of the fuel cell is used as the discharged gas.

36. A humidity control method for a fuel cell, comprising:
providing a moisture carrier so as to be in contact with fuel gas to be supplied to the fuel electrode side of a fuel cell;
separating discharged gas having a humidity different from that of the fuel gas and the fuel gas by the moisture carrier; and
carrying moisture between the fuel gas and the discharged gas using the moisture carrier.

37. The humidity control method for a fuel cell according to claim 36, wherein
the discharged gas contains oxygen and is supplied to an oxygen electrode side of the fuel cell.

38. The humidity control method for a fuel cell according to claim 36, wherein
air existing outside of the fuel cell is used as the discharged gas.
